(19) United States
(12) Patent Application Publication
(10) Pub. No.: US 2022/0193729 A1
(43) Pub. Date: Jun. 23, 2022

(54) METHOD AND APPARATUS FOR HANDLING GOODS, AND STORAGE MEDIUM

(71) Applicant: Beijing Kuangshi Robotics Technology Co., Ltd., Beijing (CN)

(72) Inventor: Deping Chen, Beijing (CN)

(21) Appl. No.: 17/593,162

(22) PCT Filed: Aug. 16, 2019
(86) PCT No.: PCT/CN2019/101086

§ 371 Date: Sep. 10, 2021

(30) Foreign Application Priority Data
Apr. 17, 2019 (CN) 201910310630.1

(51) Int. Cl. B07C 3/02; B07C 1/20; B07C 3/14

(52) U.S. Cl. CPC B07C 3/02; B07C 3/14; B07C 1/20

(57) ABSTRACT

A method for handling goods includes: acquiring goods information of goods to be sorted; determining, according to the goods information, a target sorting container from a plurality of candidate sorting containers, wherein the target sorting container is located on a sorting container moving device, and a plurality of sorting containers are placed on the sorting container moving device; and if the target sorting container is not located at a goods receiving position corresponding to the goods to be sorted, controlling the sorting container moving device to move the target sorting container to the goods receiving position, and controlling a sorting device to deliver the goods to be sorted to the target sorting container; or if the target sorting container is located at the goods receiving position corresponding to the goods to be sorted, controlling the sorting device to deliver the goods to be sorted to the target sorting container.

This application claims priority to Chinese Patent Disclosure No. 201910310630.0 filed on Apr. 17, 2019, the disclosure of which is hereby incorporated by reference in its entirety.

### TECHNICAL FIELD

The present disclosure relates to the field of control, and more specifically to a method for handling goods and an apparatus for handling goods, and storage medium.

### BACKGROUND

With the rapid development of the Internet, more and more users purchase goods by online shopping. At present, online shopping products can be stored in warehouses, which is convenient for managing online shopping products. Considering that the same order can include multiple products, it is necessary to merge multiple products in the same order, that is, sort all the products in the same order into the corresponding sorting container, and there are no products included in other orders other than the same order in the sorting container.

### SUMMARY

In view of the foregoing problems, there is provided in embodiments of the present disclosure, a method for handling goods, an apparatus for handling goods and a computer readable storage medium, which can improve the efficiency of order merging.

In order to solve the above-mentioned problems, according to a first aspect of the embodiments of the present disclosure, there is provided a method for handling goods, including:

acquiring goods information of a goods to be sorted;

determining, according to the goods information, a target sorting container from a plurality of candidate sorting containers, wherein the target sorting container is located on a sorting container moving device, and a plurality of sorting containers are placed on the sorting container moving device;

controlling the sorting container moving device to move the target sorting container to a goods receiving position, and controlling a sorting device to deliver the goods to be sorted to the target sorting container, when the target sorting container is not located at a goods receiving position corresponding to the goods to be sorted; or,

controlling the sorting device to deliver the goods to be sorted to the target sorting container, when the target sorting container is located at a goods receiving position corresponding to the goods to be sorted.

According to a second aspect of the embodiments of the present disclosure, there is provided an apparatus for handling goods, including:

a goods information acquiring module, configured to acquire goods information of a goods to be sorted;

a sorting container determining module, configured to determining, according to the goods information, a target sorting container from a plurality of candidate sorting containers, wherein the target sorting container is located on a sorting container moving device, and a plurality of sorting containers are placed on the sorting container moving device;

a goods delivery processing module, configured to control the sorting container moving device to move the target sorting container to a goods receiving position, and controlling a sorting device to deliver the goods to be sorted to the target sorting container, when the target sorting container is not located at the goods receiving position corresponding to the goods to be sorted; or,

a goods delivering module, configured to control the sorting device to deliver the goods to be sorted to the target sorting container, when the target sorting container is located at a goods receiving position corresponding to the goods to be sorted.

According to a third aspect of the embodiments of the present disclosure, there is provided an apparatus for handling goods, including a processor and a memory, wherein:

the processor executes computer program codes stored in the memory to implement the method for handling goods according to the present disclosure.

According to a fourth aspect of the embodiments of the present disclosure, there is provided a computer readable storage medium having stored thereon computer programs that, when executed by a processor, implement the steps of the method for handling goods according to the present disclosure.

### BRIEF DESCRIPTION OF THE DRAWINGS

FIG. 1 is a structural block diagram of an embodiment of a system for processing goods of the present disclosure;

FIG. 2 is a schematic diagram of a sorting device in the system for processing goods of the present disclosure;

FIG. 3 is a schematic diagram of a transfer branch in the system for processing goods of the present disclosure;

FIG. 4 is a schematic diagram of a transfer branch in the system for processing goods of the present disclosure;

FIG. 5 is a flowchart of steps of an embodiment of a method for handling goods of the present disclosure;

FIG. 6 is a flowchart of steps of an embodiment of a method for handling goods of the present disclosure;

FIG. 7 is a flowchart of steps of an optional embodiment of a method for handling goods of the present disclosure;

FIG. 8 is a structural block diagram of an embodiment of an apparatus for handling goods of the present disclosure;

FIG. 9 is a structural block diagram of an optional embodiment of an apparatus for handling goods of the present disclosure;

FIG. 10 is a structural block diagram of an optional embodiment of an apparatus for handling goods of the present disclosure;

FIG. 11 is a structural block diagram of an optional embodiment of an apparatus for handling goods of the present disclosure;

FIG. 12 is a structural block diagram of an optional embodiment of an apparatus for handling goods of the present disclosure;

FIG. 13 is a structural block diagram of an optional embodiment of an apparatus for handling goods of the present disclosure;

FIG. 14 is a structural block diagram of an optional embodiment of an apparatus for handling goods of the present disclosure;

FIG. 15 is a structural block diagram of an optional embodiment of an apparatus for handling goods of the present disclosure;

FIG. 16 is a structural block diagram of an optional embodiment of an apparatus for handling goods of the present disclosure;

FIG. 17 is a structural block diagram of an optional embodiment of an apparatus for handling goods of the present disclosure;

FIG. 18 is a structural block diagram of an optional embodiment of an apparatus for handling goods of the present disclosure;

FIG. 19 is a structural block diagram of an optional embodiment of an apparatus for handling goods of the present disclosure;

FIG. 20 is a schematic diagram of a hardware structure of an apparatus for handling goods of the present disclosure;

FIG. 21 is a cam structure in the system for processing goods of the present disclosure; and

FIG. 22 is a magnetic fluid structure in the system for processing goods of the present disclosure.

### DETAILED DESCRIPTION

In order to make the above object, features, and advantages of the present disclosure more apparent and understandable, the disclosure will be further described in detail below in conjunction with the accompanying drawings and specific implementations.

In known technologies, a small sorting device is usually used for the above order merging process. However, the currently used small sorting device cannot meet the demands of the order merging for a large number of orders at the same time, and the efficiency of the order merging is relatively low.

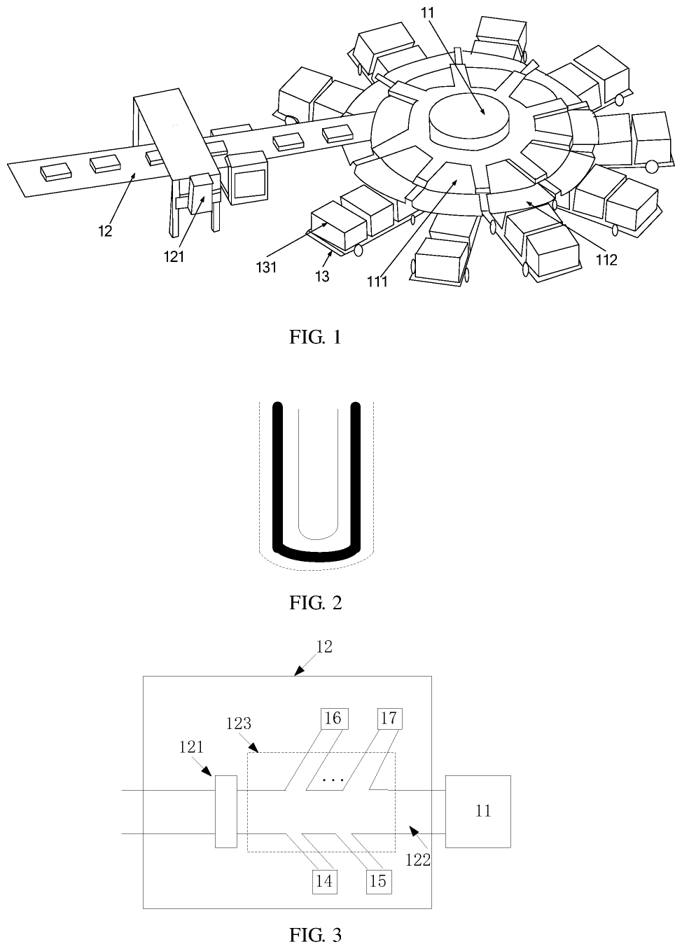

Referring to FIG. 1, there is shown a schematic structural diagram of a system 10 for processing goods, as shown in FIG. 1, the system 10 includes: a sorting device 11, and at least one transfer device 12 abutting the sorting device 11, and the sorting device 11 is provided with a plurality of material bins/feed ports 111 for placing goods to be sorted, a sorting container moving device 13 is provided at a delivery position of each delivery port 112 of the sorting device 11, and the sorting container moving device 13 is used to place a plurality of sorting containers 131.

Herein, the transfer device 12 is configured to transfer the goods to be sorted to a target material bin of the sorting device 11. In order to be able to collect the aforementioned goods information, in a possible implementation, an information collecting apparatus 121 can be provided on the transfer device 12, such that the transfer device 12 can collect the goods information of the goods to be sorted by the information collecting apparatus 121, for example, the information collecting apparatus includes: a two-dimensional code scanning apparatus, a barcode scanning apparatus, or an RFID (Radio Frequency Identification) scanning apparatus, etc., the information collector can be installed at the position as shown in FIG. 1, and certainly the present disclosure does not limit the specific installation position. In this way, the goods information of the goods to be sorted can be obtained through the information collecting apparatus, and the goods information can include at least one of the following: an identifier of the target order to which the goods to be sorted belong, an target goods identifier corresponding to the goods to be sorted, and an target goods volume of the goods to be sorted and other information; in another possible implementation, the goods to be sorted can be scanned by manually holding the information collecting apparatus, at this time, the information collecting apparatus can also be a portable collection apparatus such as a scanning gun, and the above examples are just illustrative, which are not limited in the present disclosure.

In the embodiments of the present disclosure, the sorting container moving device 13 is configured to move the target sorting container corresponding to the goods to be sorted to the goods receiving position, wherein the target sorting container can be determined through the above collected goods information; the sorting device 11 is configured to move the target material bin to the target delivery port corresponding to the target sorting container moving device where the target sorting container is located, and deliver the goods to be sorted via the target delivery port to the target sorting container. It can be seen from the above system for processing goods that since the plurality of sorting containers 131 are placed on the sorting container moving device 13, and the sorting container 131 can be moved by the sorting container moving device 13, in such a manner, the plurality of sorting containers 131 on the sorting container moving device can be delivered through each delivery port 111, thereby increasing the number of sorting containers that can be delivered by the same sorting device 11, and enabling to realize the order merging for a large number of orders at the same time.

In the embodiment of the present disclosure, the delivery position of the delivery port can be located below the delivery port, and at this time, the goods receiving position in the present disclosure is the position exactly facing the target delivery port, such that the goods to be sorted which are delivered from the target delivery port can be received; optionally, the delivery port is provided with a guide mechanism, and the delivery position of the delivery port can be below the output end of the corresponding guide mechanism, and at this time, the goods receiving position in the present disclosure is the position where the goods to be sorted which are delivered from the target delivery port can be exactly received, the guiding mechanism can be a slide rail or a conveyor belt, etc. and the above examples are just illustrative, which are not limited in the present disclosure. In addition, in some embodiments, by providing a guide mechanism at the delivery port, the impact force produced when the goods fall can also be reduced, so as to prevent the goods from being damaged by greater impact force when falling into the sorting container. Optionally, in another embodiment of the present disclosure, the sorting container can be made of elastic materials, or an air pillow or an elastic cushion can be placed on the inner bottom of the sorting container to further reduce the impact force produced when the goods fall.

Herein, the sorting device in the present disclosure can drive the plurality of material bins to rotate periodically. Specifically, the sorting device can be rotated in the following two modes, and the goods to be sorted are delivered to the target sorting container via the target delivery port in the following modes under the corresponding rotation mode:

Mode one, the sorting device rotates in a rotary manner, and at this time, the sorting device is a turntable sorting device, and the turntable sorting device includes sorting devices capable of rotating, such as a round sorting device or an oval sorting device, etc., for example a square sorting device or rectangular sorting device, etc. In this way, in a possible implementation, a transfer apparatus can be disposed at the bottom of the target material bin, and the transfer apparatus moves the goods to be sorted placed on the target material bin to the target delivery port corresponding to the target sorting container moving device. The transfer apparatus can be realized by conveyor belts, rollers, belts, chains, rolling axis, or transfer trolley wheels, etc. If the delivery port in the present disclosure is disposed at a position on the side of the sorting device close to the center of the platform, the goods to be sorted on the target material bin can be moved from the current position to the position on the side close to the center of the platform to realize the delivery of the goods to be sorted. If the delivery port in the present disclosure is disposed at a position of the edge of the platform of the sorting device, the goods to be sorted on the target material bin can be moved from the current position to the position of the edge of the platform to realize the delivery of the goods to be sorted. In addition, the use of circular sorting device in the system for processing goods is conducive to reducing the space occupied by the sorting device, and because the circular sorting device can employ a driving mechanism (such as a motor) to provide power, it is conducive to reducing the cost of the sorting device.

In another possible implementation, a transfer apparatus can be disposed on the inner wall of the target material bin of the sorting device, and the transfer apparatus can be a push rod, a telescopic arm or a high-pressure air blowing apparatus, so as to move the goods to be sorted on the target material bin to the target delivery port corresponding to the target sorting container moving device. Herein, if the delivery port in the present disclosure is disposed at a position on the side of the sorting device close to the center of the platform, the goods to be sorted on the target material bin can be moved from the current position to a position close to the center of the platform to realize the delivery of the goods to be sorted. If the delivery port in the present disclosure is disposed at a position of the edge of the platform of the sorting device, the goods to be sorted on the target material bin can be pushed from the current position to the position of the edge of the platform to realize the delivery of the goods to be sorted.

Mode two, the sorting device rotates reciprocally, and at this time, the sorting device is a reciprocating sorting device including a sorting device capable of reciprocating, such as an L-type sorting device or a U-type sorting device, etc., for example, a linear sorting device. In this way, in a possible implementation, if the delivery port in the present disclosure is disposed at a position on a side of outer edge of the sorting device, the goods to be sorted on the target material bin can be moved from the current position to a position on the side of outer edge to realize the delivery of the goods to be sorted. If the delivery port in the present disclosure is disposed at a position on a side of inner edge of the sorting device, the goods to be sorted on the target material bin can be moved from the current position to the position on the side of the inner edge to realize the delivery of the goods to be sorted. Herein, taking a U-type sorting device as an example, as shown in FIG. 2, if the thick solid line “U” in FIG. 2 represents the U-type sorting device, the thin solid line “U” in FIG. 2 represents the side of the inner edge, and the dotted line “U” in FIG. 2 represents the side of the outer edge.

In another possible implementation, a transfer apparatus can be disposed on the inner wall of the target material bin of the sorting device, and the transfer apparatus can be a push rod, a telescopic arm or a high-pressure air blowing apparatus, so as to move the goods to be sorted on the target material bin to the target delivery port corresponding to the target sorting container moving device. Herein, if the delivery port in the present disclosure is disposed at a position on the side of the outer edge of the sorting device, the goods to be sorted on the target material bin can be moved from the current position to the position on side of the outer edge to realize the delivery of the goods to be sorted. If the delivery port in the present disclosure is disposed at a position on the side of the inner edge of the sorting device, the goods to be sorted on the target material bin can be pushed from the current position to the position on the side of the inner edge to realize the delivery of the goods to be sorted. The above-mentioned reciprocating sorting device is just illustrative, which is not limited in the present disclosure.

Optionally, the sorting device 11 in the present disclosure is configured to drive a plurality of material bins 111 to rotate periodically. Herein, in a possible implementation, the material bin 111 of the sorting device 11 has a corresponding relationship with the delivery port 112, that is, the material bin A1 has a corresponding relationship with the delivery port P1, the material bin A2 has a corresponding relationship with the delivery port P2, . . . , and the material bin An has a corresponding relationship with the delivery port Pn, where n is a positive integer such that the sorting device 11 can simultaneously drive each material bin and the delivery port having a corresponding relationship with each material bin to perform periodic rotation; in another possible implementation, there is no corresponding relationship between the material bin 111 of the sorting device 11 and the delivery port 112 such that the sorting device 11 drives the plurality of material bins 111 to rotate periodically while the delivery port 112 of the sorting device 11 may not rotate, that is, the position of the delivery port is fixed.

In addition, as shown in FIG. 3, in a possible implementation, an information collecting apparatus 121 is provided on the transfer device 12, and each transfer device 12 includes a plurality of transfer branches, wherein the first transfer branch 122 is docked with the sorting device 11, and used to transfer the goods to be sorted to the material bin of the sorting device 11, which can be directly transferred to the material bin in the present disclosure. In order to improve the transfer efficiency of transferring goods to the material bin, the disclosure can also transfer the goods to be sorted onto the central platform of the sorting device through the first transfer branch 122, so as to realize, on the central platform, the simultaneous transfer of the plurality of goods to be sorted to the corresponding material bin; the second transfer branch 123 is respectively connected to a buffer container 14, a next processing station 15, a return device 16 or another sorting device 17, and is configured to transfer the goods to be sorted to the buffer container 14, the next processing station 15, the return device 16 or another sorting device 17, that is, the second transfer branch includes a first sub-branch, a second sub-branch, a third sub-branch, and a fourth sub-branch, etc., the first sub-branch is configured to be connected to the buffer container 14, so as to transfer the goods to be sorted to the buffer container 14, the second sub-branch is configured to be connected to the next processing station 15, to transfer the goods to be sorted to the next processing station 15, the third sub-branch is configured to be connected to the return device 16, so as to transfer the goods to be sorted to the return device 16, and the fourth sub-branch is configured to be connected to another sorting device 17, so as to transfer the goods to be sorted to another sorting device 17, etc.

Herein, the buffer container 14 is configured to place goods suspended for sorting, such that the control device can acquire the goods suspended for sorting from the buffer container when it is determined to perform sorting processing on the goods suspended for sorting. For example, the buffer container 14 can include a container for buffering goods, such as a material box, a shelf, or a storage basket.

The next processing station 15 can be a packaging station, that is, to perform processing operations such as order review, goods packaging etc.

The return device 16 can return the goods diverged from the transfer device 12 to the transfer device 12 again. For example, the transfer device 12 can diverge the goods that currently do not meet predetermined sorting conditions to the transfer branch connected to the return device, and the return device 17 returns the goods to the transfer device 12 after waiting for the goods to meet the predetermined sorting conditions so as to retrieve the goods information of the goods and perform the sorting operation.

The another sorting device 17 can be a sorting device that operates independently of the sorting device 11. For example, when the goods to be sorted are the first delivery sorted goods in the order to which the goods to be sorted belong, if there are not enough idle sorting containers on the sorting device 11 at this time, the transfer device 12 can be controlled to diverge part of the goods to the transfer branch connected to the another sorting device 17, and a sorting operation is performed on the goods by the other sorting device 17. In this way, the efficiency of sorting can be improved such that the overall efficiency of warehoused goods sorting can be raised.

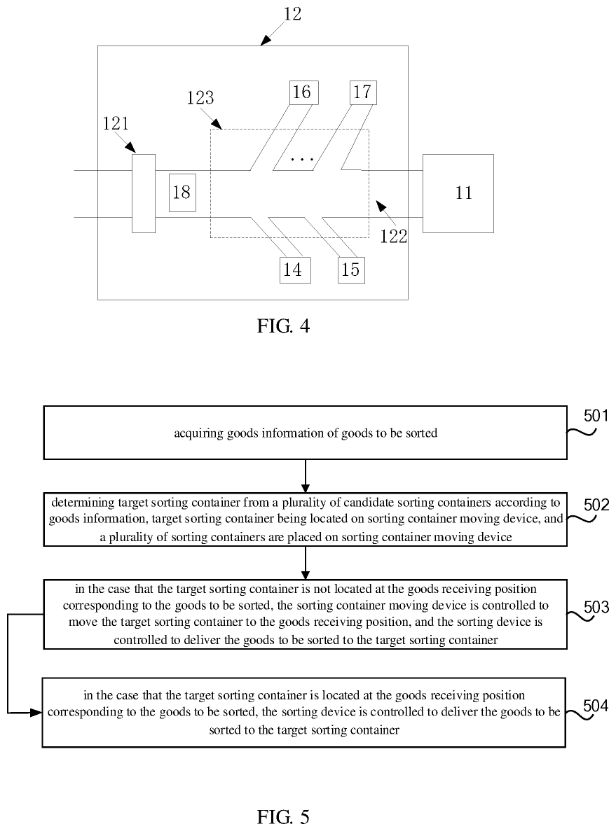

In addition, in other embodiments, as shown in FIG. 4, the system 10 further includes: a diverging device 18 configured to perform the diversion processing on the goods to be sorted on the transfer device 12, to diverge the different goods to be sorted to different transfer branches in the transfer device 12. In this way, since the goods to be sorted cannot be sorted through the sorting device, the present disclosure needs to use the sorting device to perform corresponding diversion processing on the different goods to be sorted. For example, the diverging device 18 can be disposed on the transfer device 12 (as shown in FIG. 4). Certainly, the present disclosure can also dispose the diverging device 18 in a manner of docking with the transfer device, the diverging device in the present disclosure can include a sorting rotating gear arm, a sweeping disc type pushing device, a slider diverging device, a tape floating type diverging device, a roller floating type diverging device or a slat tilting type diverging device, etc., and the above examples are just illustrative, which are not limited in the present disclosure.

At least one transfer device 12 in the system 10 for processing goods can include multiple transfer devices, and the system 10 for processing goods can further include a control device connected to the multiple transfer devices 12, which is configured to control at least one of the multiple transfer devices 12 to enter a working mode or an idle mode. When there is one transfer device in the working mode (that is, the one transfer device conveys the goods to be sorted to the sorting device 11), the system for processing goods can be called as a single feeding port mode; and when there are multiple transfer devices in the working mode (that is, the multiple transfer devices simultaneously convey the goods to be sorted to the sorting device 11), the system for processing goods can be called as a multi-feeding port mode, which can improve the sorting efficiency of a single sorting device.

For example, part of the transfer devices can be controlled to enter the working mode, and after the part of the transfer devices enters the working mode, if the quantity of goods to be sorted is large, a first transfer device in the other part of the transfer devices can be controlled to enter the working mode to realize the function of simultaneously supplying the goods to be sorted to the material bin of the sorting device by multiple feeding ports, so as to improve the sorting efficiency. If there are a small number of goods to be sorted, a second transfer device in the part of the transfer devices can be controlled to enter the idle mode. It can be seen that the present disclosure can control at least one of the plurality of transfer devices 12 to enter the working mode or the idle mode based on the state of the quantity of goods to be sorted. Certainly, the present disclosure can also control the sorting efficiency of the sorting device 11 by controlling the transfer speed of the transfer device 11. For example, when the quantity of goods to be sorted is large, the transfer speed of the transfer device 12 and the rotation speed of the turntable of the sorting device 11 can be increased synchronously to improve the sorting efficiency of the sorting device 11; and when the quantity of goods to be sorted is not large, he transfer speed of the transfer device 11 and the rotation speed of the turntable of the sorting device 11 can be reduced. It should be noted that if the goods to be sorted are transferred to the central platform of the sorting device 11 and the goods to be sorted are released to the material bin on the central platform in the present disclosure, at least one of the plurality of transfer devices 12 can be controlled at this time to enter the working mode or the idle mode based on situations of the accumulation of goods on the central platform.

In an embodiment, if the goods to be sorted are directly transferred to the material bin on the sorting device 11, a speed correspondence relationship is satisfied between the moving speed of the material bin on the sorting device and the transfer speed of the at least one transfer device. The speed correspondence relationship includes the following formula:

v=u*n

where v represents the moving speed of the material bin on the sorting device (a number of moving bits/hour), u represents the transfer speed of the transfer device (a number of transfer pieces/hour), and n is used to represent a number of transfer devices where the at least one transfer device is in a working mode. The number of moving bits is the number of times that all the material bins on the sorting device pass through the feeding port corresponding to at least one transfer device in the working mode.

In a possible implementation, the above-mentioned control device is connected to the sorting container moving device, and when the sorting container moving device includes a mobile trolley, the control device is configured to control the mobile trolley (such as moving back and forth, and/or moving left and right) to move, such that the target sorting container on the mobile trolley moves to the goods receiving position. In another possible implementation, a transfer apparatus can be provided on the sorting container moving device, and the control device 11 is configured to control the transfer apparatus to move the target sorting container on the target sorting container moving device to the goods receiving position. Herein, the transfer apparatus can include any of the following: conveyor belt, roller, belts, chains, rolling axis, push rods, etc. In yet another possible implementation, the sorting container moving device includes a mobile trolley, and the mobile trolley is provided with a transfer apparatus. In this way, the control device in the present disclosure can control the mobile trolley to move (such as moving back and forth, and/or, moving left and right), and at the same time control the target sorting container on the mobile trolley to move too, to enable the target sorting container to quickly move to the goods receiving position.

In the process of moving the target sorting container to the goods receiving position, it is usually necessary for the system to supply power to move in the above three modes, in order to solve this problem, the target sorting container moving device 13 in the present disclosure is provided with an equipment power apparatus; or the sorting device 11 is provided with a sorting power apparatus; or, the system includes an external power device, which can be disposed at a position below the sorting device 11, etc.; the sorting power apparatus, the equipment power apparatus, and the external power device are all configured to provide power to the mobile trolley to enable the target sorting container on the mobile trolley to move to the goods receiving position; or provide power to the transfer apparatus to enable the transfer apparatus to drive the target sorting container to move to the goods receiving position. In other words, the sorting container moving device can provide its own power to control the movement of the sorting container placed on the sorting container moving device; or, other devices can also provide power to the sorting container moving device to control the transfer device on the sorting container moving device to drive the sorting container to move.

In the embodiments of the present disclosure, the aforementioned sorting power apparatus and external power device can be connected to the sorting container moving device in any of the following modes, and for ease of description, the sorting power apparatus and external power device can be collectively referred to as the transmission mechanism:

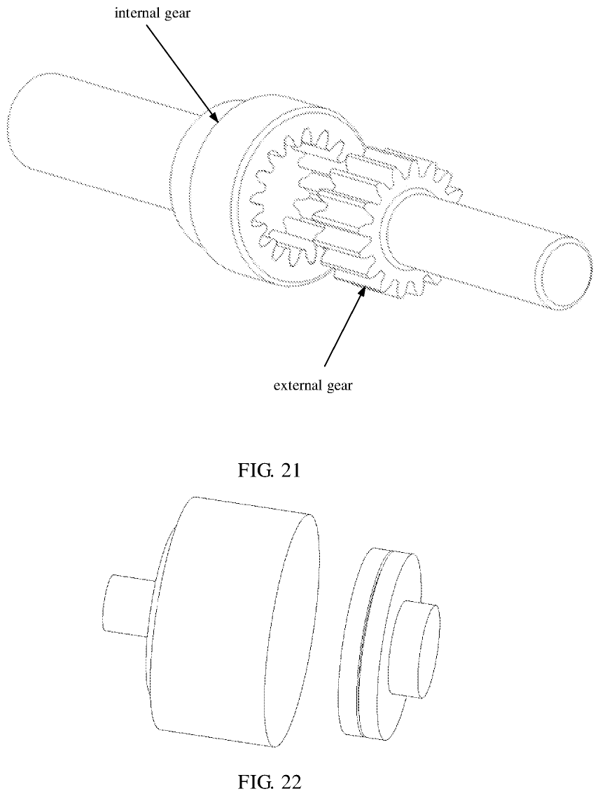

Mode one, a gear transmission connection mode: a gear mechanism can be provided at one end of the sorting container moving device, and when the sorting container moving device moves below the delivery port, the gears on the sorting container moving device mesh with the gears on the transmission mechanism, such that the transmission mechanism transmits the transmission power to the sorting container moving device through two gears to control the sorting container moving device to move, or the transmission mechanism transmits the transmission power to the transfer apparatus on the sorting container moving device through two gears to control the transfer apparatus to rotate, so as to achieve the function of moving the sorting container on the material bin moving device. For example, as shown in FIG. 21, a gear structure is shown, in which an internal gear in FIG. 21 can be disposed at one end of the sorting container moving device, and an external gear can be disposed at one end of the transmission mechanism, or the external gear in FIG. 21 can be disposed at one end of the sorting container moving device, and the internal gear is disposed at one end of the transmission mechanism.

Mode two, a shaft transmission connection mode: one end of the sorting container moving device is provided with a driven wheel shaft sleeve, when the sorting container moving device moves below the delivery port, the driving shaft on the transmission mechanism is inserted into the driven wheel shaft sleeve to achieve the meshing of the both, to enable the transmission mechanism to transmit the transmission power to the sorting container moving device through the shaft transmission so as to control the sorting container moving device to move, or the transmission mechanism transmits the transmission power to the transfer apparatus on the sorting container moving device through the shaft transmission to control the transfer apparatus to rotate so as to achieve the function of moving the sorting container on the material bin moving device.

Mode three, a belt transmission connection mode: one end of the sorting container moving device is provided with a driven gear, when the sorting container moving device moves below the delivery port, the transmission mechanism moves the toothed belt to the driven gear to achieve meshing, to enable the transmission mechanism to transmit the transmission power to the sorting container moving device through belt transmission so as to control the sorting container moving device to move, or the transmission mechanism transmits the transmission power to the transfer apparatus on the sorting container moving device through belt transmission to control the transfer apparatus to rotate, so as to achieve the function of moving the sorting container on the material bin moving device.

Mode four, a magnetic fluid transmission connection mode: in this mode, the magnetic fluid can be used as a transmission medium of the transmission mechanism, and the transmission mechanism outputs a rotating magnetic field, such that the sorting container moving device enters the rotating magnetic field, and the magnetic lines of force of the rotating magnetic field intersect with tangent lines of the contact points in the sorting container moving device to enable the sorting container moving device to obtain the transmission power so as to control the sorting container moving device to move, or the transfer apparatus enters the rotating magnetic field, and the magnetic field lines of force of the rotating magnetic field intersect with the tangent lines of the contact points in the transfer apparatus to enable the transfer apparatus to obtain the transmission power to rotate, so as to achieve the function of driving the sorting container to move. For example, as shown in FIG. 22, two ends of a magnetic fluid structure are shown, any end of the magnetic fluid structure can be disposed on the transmission mechanism, and another end thereof can be disposed on the sorting container moving device.

The above four modes of connections are just illustrative, which are not limited in the present disclosure. In addition, in the former three modes mentioned above, the transmission mechanism can also be directly connected to the transfer apparatus, such that the transmission mechanism can directly transmit the transmission power to the transfer apparatus. In summary, in the present disclosure, power can be transmitted to the sorting container moving device and/or transfer apparatus through different transmission connection modes, such that the sorting container can be moved.

The present disclosure is certainly not limited to the above-mentioned modes, for example, when the sorting device 11 is provided with a sorting power apparatus, the sorting device and the sorting container moving device can be connected. For example, the sorting container moving device is connected to the sorting device through a hook mode, such that the sorting power apparatus on the sorting device can control the sorting container moving device to move; or the sorting containers closest to the sorting device, on the sorting container moving device, can be connected to the sorting device through a hook mode, and the sorting containers on the sorting container moving device are connected to each other, such that the sorting power apparatus on the sorting device can control the sorting containers to move, and the above examples are just illustrative, which are not limited in the present disclosure.

When the sorting containers on the sorting container moving device are in an order completed state, it is usually necessary to change the bin (replace the bin) for the sorting containers. In order to prompt the user to perform the operation of changing the bin for the sorting containers in the order completed state, the sorting container moving device can be provided with a prompting apparatus to indicate the order state corresponding to the sorting containers on the sorting container moving device. Herein, the prompting apparatus includes at least one of the following: a light prompter, a display screen prompter, and a voice prompter.

When the prompting apparatus includes a prompter, in a possible implementation, if at least one sorting container on the sorting container moving device is in the order completed state, a light prompt can be performed, and if all the sorting containers on the container sorting moving device are in the order uncompleted state, no light prompts is needed. In another possible implementation, if at least one sorting container on the sorting container moving device is in the order completed state, a prompt can be performed with a first predetermined flashing color, and if all the sorting containers on the sorting container moving device are in the order uncompleted state, a prompt can be performed with a second predetermined flashing color.

Considering that there are plurality of sorting containers on the sorting container moving device, in order to better prompt the user of a replacement sorting container to be replaced, prompting modes can be set respectively for the plurality of sorting containers on the sorting container moving device. In a possible implementation, a light source (such as light strips, bulbs, LED lights, etc.) can be disposed at a position adjacent to each sorting container on the sorting container moving device, or a light source can be disposed on the sorting container, so as to indicate the order state of the sorting container by controlling the light source switching or flashing based on different colors/frequencies, for example, a green or blue light indicates that the sorting container is in an order completed state; a red light or light source power off indicates that the sorting container is an order uncompleted state, or light flashing can be used to indicate that the sorting container is in order completed state. In another possible implementation, a light source can also be disposed in other places, and the order state of the sorting container can be indicated by projecting a light spot on the sorting container, for example, the light spot of different colors can be used to indicate different order states of the sorting container, and whether there is a light spot on the sorting container can also be used to indicate the different order states of the sorting container. In yet another possible implementation, flashing parameters can be set for the plurality of sorting containers on the sorting container moving device, if the flashing parameters include flashing duration, the user can determine replacement sorting container to be replaced based on the flashing duration; if the flashing parameters include the flashing frequency, the user can determine the replacement sorting container to be replaced based on the flashing frequency; and if the flashing parameters include the flashing colors, the user can determine the replacement sorting container to be replaced based on the flashing colors, etc.

In some embodiments, if all of the sorting containers on the sorting container moving device are in the order uncompleted state, it is necessary to promptly replace the containers in an entire row for the sorting container moving device, and if part of sorting containers on the sorting container moving device are in the order uncompleted state, it can be decided whether to replace this part of sorting containers. Therefore, the present disclosure can provide different prompts for the above two situations. For example, if all the sorting containers on the sorting container moving device are in the order completed state, the prompt is performed based on the first predetermined flashing mode, and if partial sorting containers on the sorting container moving device are in the order completed state, the prompt is performed based on the second predetermined flashing mode.

In some other embodiments, when the prompting apparatus includes a display screen prompter, the order states respectively corresponding to plurality of sorting containers on the sorting container moving device can be displayed on the display screen. Since the user pays more attention to the sorting container in the order completed state, a box number of the sorting container in the order completed state can be displayed on the display screen based on the predetermined font style, for example, the predetermined font style is a bold, red, second font etc. Certainly, there can further display only, in the present disclosure, the bin number of the sorting container whose order state is the order completed state on the display screen, such that the user can easily view, etc.

In yet another embodiment, when the prompting apparatus includes a voice prompter (such as a speaker, etc.), in the present disclosure the order state of the sorting container on the sorting container moving device can be indicated through the voice prompter, such as through the voice message “the fourth sorting container on the fifth sorting container moving device is in order completed state, please replace the container”, or “all of the sorting containers on the seventh sorting container moving device are in order completed state, please replace the container in the entire row” etc. In addition, the order state of the sorting container on the sorting container moving device can be indicated, in the present disclosure, through any combination of light prompters, display screen prompters, and voice prompters, and the above examples are just illustrative, which are not limited in the present disclosure.

In addition, the control device 11 in the present disclosure is also configured to control the sorting container moving device 13 to move from the current position to the target position where the next processing station is located, when the plurality of sorting containers 131 included in the target sorting container moving device 13 are all in the order completed state. Certainly, in the present disclosure, the plurality of sorting containers can also be unloaded, such as by means of manual unloading and/or automatic unloading, and the unloaded plurality of sorting containers are transported to the next processing station through the transportation equipment, such as the transportation equipment can be Forklifts, AGVs (Automated Guided Vehicles), etc., and then multiple idle sorting containers are placed on the sorting container moving device, such that the sorting container moving device can continue to carry out the goods processing process in the present disclosure.

After controlling the sorting container moving device 13 to move from the current position to the target position where the next processing station is located, if the current position is not placed with a new sorting container moving device, the number of the sorting containers in the system for processing goods is less, and in order to avoid this problem, the system in the present disclosure further includes: multiple standby sorting container moving devices; and multiple idle sorting containers are placed on the standby sorting container moving device; in this way, the control device 11 is further configured to acquire a new sorting container moving device from the standby sorting container moving devices, after the sorting container moving device 13 moves from the current position to the target position where the next processing station is located, and control the new sorting container moving device to move to the current position, such that the number of sorting containers in the system for processing goods remains unchanged.

It should be noted that the control device in the present disclosure can be a local server, a cloud server, etc., and the control device can also be connected to at least one transfer device, a sorting device, and a sorting container moving device by wired or wireless connection, respectively, such that it is possible to control the at least one transfer device, the sorting device, and the sorting container moving device to perform the above process, which will not be repeated. The control device can communicate with the transfer device, the sorting device or the sorting container moving equipment through wired signals or wireless signals.

The above-mentioned system for processing goods is adopted, which includes a sorting device, and at least one transfer device docked with the sorting device, the sorting device is provided with a plurality of material bins for placing the goods to be sorted, a sorting container moving device is provided at the delivery position of each delivery port of the sorting device, and the sorting container moving device is configured to place a plurality of sorting containers; herein, the transfer device is configured to collect the goods information of the goods to be sorted, and transfer the goods to be sorted to the target material bin of the sorting device; the sorting container moving device is configured to move the target sorting containers correspond to the goods to be sorted to the goods receiving position based on the goods information; the sorting device is configured to move the target material bin to the target delivery port corresponding to the target sorting container moving device where the target sorting container is located, and deliver the goods to be sorted to the target sorting container via the target delivery port. In this way, because plurality of sorting containers are disposed on the sorting container moving device in the present disclosure, the system for processing goods has a larger number of sorting containers, and every sorting container can perform the order merging for a single order, such that the system for processing goods can merge a large number of orders at the same time, which improves the efficiency of order merging.

The embodiments of the present disclosure further provides a sorting container moving device, and the sorting container moving device includes: a body, which is provided with a placing area for placing a plurality of sorting containers; wherein, the body can control the movement of the plurality of sorting containers.

Herein, rolling wheels and/or universal wheels, etc. can be provided on the body, such that the body can be moved, and the plurality of sorting containers can be laid flat on the placing area.

Since the order states corresponding to the sorting containers in the present disclosure can change, and the order states include order completed state and order uncompleted state, the present disclosure needs to prompt to replace the sorting containers based on the order states, therefore, in the present disclosure, a prompting apparatus is provided on the sorting container moving device, and the prompting apparatus is configured to indicate the order states corresponding to a plurality of sorting containers; wherein, the prompting apparatus includes at least one of the following: a light prompter, a display screen prompter, and a voice prompter. Also, the prompting apparatus can be disposed at a position corresponding to the sorting container around the placing area, and the specific prompting process can refer to the discussion in the first embodiment, which will not be repeated.

In addition, the body in the present disclosure can further include a control module and a transfer apparatus, and the placing area is located on the transfer apparatus, at this time, the transfer apparatus can be a conveyor belt, a roller, a belt, a chain, a rolling axis, etc.; or the placing area is located at a position opposite to the transfer apparatus, at this time, the transfer apparatus can be a push rod, etc., which is not limited in the present disclosure, and the control module is configured to control the transfer apparatus to move the plurality of sorting containers.

The sorting container moving device further includes a transmission mechanism configured to be connected with an external power apparatus to acquire power from the external power apparatus and control the movement of the body or the transfer apparatus. The specific controlling process can refer to the examples in first embodiment, which will not be repeated.

The above-mentioned sorting container moving device is adopted, and because the plurality of sorting containers, in the present disclosure, are disposed on the sorting container moving device, the same delivery position corresponds to the plurality of sorting containers, such that the order merging can be performed for a large number of orders at the same time, which improves the efficiency of order merging.

Referring to FIG. 5, there is shown a schematic flowchart of a method for handling goods, and as shown in FIG. 5, the method includes steps 501, 502, 503, and 504.

In step 501, goods information of the goods to be sorted is acquired.

In the embodiments of the present disclosure, the goods information can include at least one of the following: the order identifier of the target order to which the goods to be sorted belong, the target goods identifier corresponding to the goods to be sorted, and the target goods volume of the goods to be sorted and other information, the above examples are just illustrative, which are not limited in the present disclosure.

In step 502, a target sorting container is determined from a plurality of candidate sorting containers based on the goods information, the target sorting container is located on a sorting container moving device, and a plurality of sorting containers are placed on the sorting container moving device.

In this step, the target sorting container can be determined through the following steps:

S11, the target order to which the goods to be sorted belong is determined based on the goods information.

In some possible implementations, a corresponding relationship between different orders and goods identifiers is set in advance, for example, there is a corresponding relationship between the first order Q1 and the goods identifiers (i.e. R1, R2, and R3), and there is a corresponding relationship between the second order Q2 and the goods identifiers (i.e. R4 and R5), etc. Considering that multiple orders can correspond to the same goods identifier, in this step, multiple orders can be acquired based on the target goods identifier, and at this time, the target order to which the target goods identifier belongs can be randomly acquired from the multiple orders. Certainly, in this step, the target order can also be determined based on a predetermined execution strategy which can include: taking the goods to be sorted as the goods included in the multiple orders, and acquiring the order sequence numbers corresponding to the multiple orders, to determine, based on the order sequence number, the target order from the multiple orders, that is, using the order with the first order sequence number as the target order, and in the present disclosure, allocating the sorting container to the order based on the order sequence number, that is, the sorting containers being allocated preferentially to the order with a top order sequence number.

In some other possible implementations, the goods information includes the order identifier of the target order to which the goods to be sorted belong, and the target order can be determined based on the order identifier.

S12, it is determined whether the goods to be sorted belong to the first delivered sorted goods in the target order.

When the goods to be sorted belongs to the first delivered sorted goods in the target order, since the target order does not have delivered sorted goods, for example, the goods to be sorted in the target order are located in the buffer container, on the shelf, or on the delivery vehicle (the delivery vehicle being used to transport the goods from the shelf to the system for processing goods), at this time, it is necessary to allocate sorting containers for the goods to be sorted. Therefore, step S13 is executed;

When the goods to be sorted do not belong to the first delivered sorted goods in the target order, in a possible implementation, because the target order already has delivered sored goods, the target order has a corresponding target sorting container, and therefore, step S14 is executed. In another possible implementation, if the target sorting container of the target order to which the goods to be sorted belong is full, it means that one sorting container cannot accommodate all the goods in the target order, and at this time, it is necessary to reallocate another sorting container to the goods to be sorted, and thus it is also needed, in the embodiments of the present disclosure, to determine whether the target sorting container corresponding to the target order is full, in the case that the target sorting container is full, another target sorting container corresponding to the target order is determined from the multiple candidate sorting containers based on a predetermined screening condition; the predetermined screening condition includes: the target sorting container is in an unoccupied state. In the case that the target sorting container is not full, if the remaining capacity of the target sorting container can accommodate the goods to be sorted, step S14 is executed.

S13, a target sorting container corresponding to the target order is determined from the multiple candidate sorting containers based on a predetermined screening condition.

Herein, if the sorting container is in an occupied state, and if the goods to be sorted are delivered to the sorting container in the occupied state, there will be goods belonging to multiple orders in the sorting container in the occupied state, so that it is impossible to achieve order merging, and thus the predetermined screening conditions in the present disclosure include: the target sorting container is in an unoccupied state.

Considering that when the sorting container is in the order completed state, the sorting container in the order completed state needs to be replaced, since the plurality of sorting containers are disposed in one sorting container moving device in the present disclosure, in order to improve the efficiency of replacing sorting containers, the sorting completion time of the plurality of sorting containers on the same sorting container moving device in the present disclosure is as close as possible, such that the plurality of sorting containers on the sorting container moving device can be replaced in the entire row.

In addition, because the volume of the goods to be sorted are different, and the total volume of all the goods included in each order is also different, for the orders with different total volumes, the sorting containers with different box models can also be used in the present disclosure, such that the orders with a larger total volume can use the sorting containers having a larger volume, and the orders with a smaller total volume can use the sorting containers having a smaller volume. It can be seen that by arranging the sorting containers with different box models, it is possible to better meet the size requirements of the goods and to make reasonable use of the box space.

In summary, the predetermined screening conditions in the present disclosure can further include: the time difference between the sorting completion times corresponding to any two sorting containers located on the same sorting container moving device being less than or equal to the predetermined time threshold; and/or, the box model of the sorting container and the total volume of all the goods included in the corresponding order conform to a predetermined correspondence relationship; and the predetermined correspondence relationship includes the corresponding relationship between different box models and the total volume range of the goods.

The time difference between the sorting completion times corresponding to any two sorting containers located on the same sorting container moving device being less than or equal to the predetermined time threshold, includes the following two cases: the first case is that the time for two sorting containers to receive the first goods in their respective corresponding orders is close, and the time period required for all goods in their respective corresponding orders to complete delivery is close; and the second case is that time interval for the two sorting containers to receive the first goods in their respective corresponding orders is relatively longer, but the time for the last goods in the respective corresponding orders to complete the delivery is close.

S14, a target sorting container corresponding to the target order is acquired.

Since the order merging is performed for the same order in the present disclosure, in this way, when there have already been the first delivered sorted goods in the target order, it can be determined that the sorting container where the first delivered sorted goods is located is the target sorting containers.

In step 503, when the target sorting container is not located at the goods receiving position corresponding to the goods to be sorted, the sorting container moving device is controlled to move the target sorting container to the goods receiving position, and the sorting device is controlled to deliver the goods to be sorted to the target sorting container.

In the embodiments of the present disclosure, in a possible implementation, when the sorting container moving device includes a mobile trolley, the sorting container moving device can be moved by the mobile trolley (such as moved back and forth, and/or moved left and right), to enable the sorting container on the mobile trolley to be moved to the goods receiving position; in another possible implementation, a transfer apparatus can be provided on the sorting container moving device, such that the sorting container on the sorting container moving device can be controlled to move by the transfer apparatus; and in yet another possible implementation, the sorting container moving device can be a mobile trolley, and a transport apparatus is provided on the mobile trolley, such that while the mobile trolley moves (such as moves back and forth, and/or, moves left and right), the sorting containers on the mobile trolley can also be moved by the transfer apparatus, thereby shortening the time for the sorting container to reach the goods receiving position.

In step 504, when the target sorting container is located at the goods receiving position corresponding to the goods to be sorted, the sorting device is controlled to deliver the goods to be sorted to the target sorting container.

For the delivery operations in step 503 and step 504, reference may be made to the delivery operations in the first embodiment, which will not be repeated here.

By adopting the above method, the goods information of the goods to be sorted is acquired first; subsequently, the target sorting container is determined from a plurality of candidate sorting containers based on the goods information, and the target sorting container is located on the sorting container moving device, on which a plurality of sorting containers are placed; then, when the target sorting container is not located in the goods receiving position corresponding to the goods to be sorted, the sorting container moving device is controlled to move the target sorting container to the goods receiving position, and the sorting device is controlled to deliver the goods to be sorted to the target sorting container; or, when the target sorting container is located at the receiving position corresponding to the goods to be sorted, the sorting device is controlled to deliver the goods to be sorted to the target sorting container. In this way, because the plurality of sorting containers is disposed on the sorting container moving device in the present disclosure, the same delivery position corresponds to the plurality of sorting containers, such that a large number of orders can be merged at the same time, and the order merging efficiency is improved.

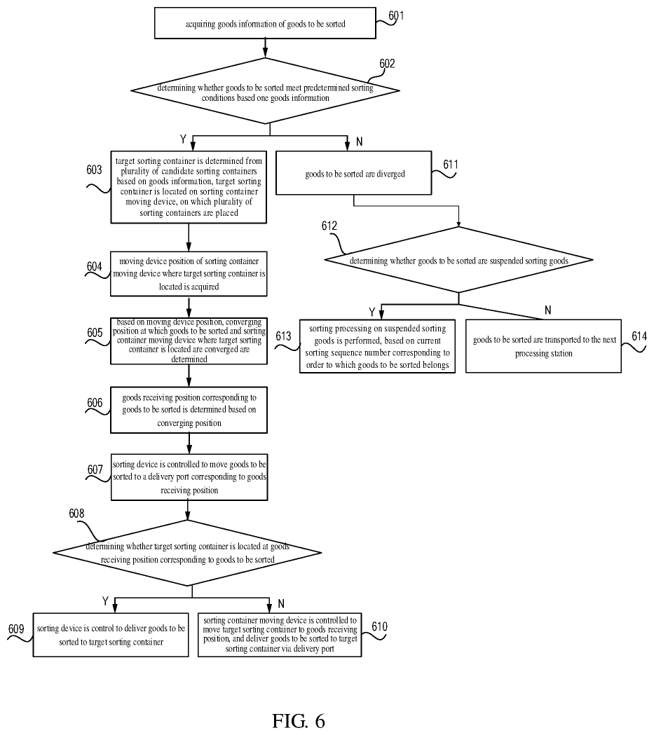

Referring to FIG. 6, there is shown a schematic flowchart of a method for handling goods, as shown in FIG. 6, the method includes:

In step 601: the goods information of the goods to be sorted is acquired.

In the embodiments of the present disclosure, the goods information can include at least one of the following: the order identifier of the target order to which the goods to be sorted belong, the target goods identifier corresponding to the goods to be sorted, and the target goods volume of the goods to be sorted and other information, and the above example is only illustrative, which is not limited in the present disclosure.

In step 602: it is determined whether the goods to be sorted meet the predetermined sorting conditions based on the goods information.

Herein, the predetermined sorting condition includes at least one of the following: the goods to be sorted do not belong to designated types of goods, for example, the designated types of goods are fragile goods (such as glass products), bulky goods, special-shaped goods, etc.; the target order to which the goods to be sorted belong includes multiple goods; the designated goods in the target order to which the goods to be sorted belong have been picked, and the designated goods are the goods in the target order other than the goods to be sorted; the designated goods in the target order to which the goods to be sorted belong arrive at the sorting device within a predetermined time; the number of idle sorting containers on all the sorting container moving device is greater than or equal to an occupying number of the containers occupied by all the goods in the target order to which the goods to be sorted belong; a current sorting sequence number corresponding to the target order to which the goods to be sorted belong, less than or equal to a sorting container number of the idle sorting containers on all the sorting container moving devices; and the target sorting container corresponding to the goods to be sorted and the sorting container corresponding to the last goods to be sorted is the same sorting container, or different sorting containers located on different sorting container moving devices.

In some embodiments, the smaller the sorting sequence number corresponding to the order, the higher the sorting priority of the order is, that is, the order with a smaller sorting sequence number will be sorted preferentially.

In some embodiments, if special types of goods are automatically sorted in the sorting device, it may cause such problems as the goods are damaged, for example, glass products are easy to break, and the large goods and special-shaped goods are easily damaged in their edges and corners, and cannot be accommodated by the sorting container, etc. Therefore, the goods belonging to the designated types of goods can be excluded from the sorting device.

In some embodiments, for a single-piece order that only includes a single piece of goods, it can directly enter the next processing process, such as order review, packaging, delivery, etc. without being transferred to a sorting device for sorting operations. By distinguishing single-piece orders from multiple-piece orders (that is, orders that include multiple pieces of goods), the overall sorting efficiency of the system can be improved. In addition, the single piece of goods referred to in this embodiment can include an individually packaged piece of goods, for example, a box of beer, a box of fruit, etc.

In some embodiments, if part of the goods in the target order to which the goods to be sorted belong have not been picked, then the goods to be sorted will occupy the buffer space where the sorting container is located for a relatively long time after being delivered to the sorting container, the utilization rate of the buffer space of the sorting container is low. Therefore, by setting the predetermined sorting conditions, the goods in the orders that have not been picked are temporarily stopped to be transferred to the sorting device, which is beneficial to improve the sorting efficiency.

In some embodiments, for a situation where one order includes multiple goods, if part of the goods in the order has reached the sorting device, and another part of the goods has not yet reached the sorting device (for example, the picking has not been completed, or they are still on the way of transfer after the picking is completed), and at this time, if part of the arrived goods is delivered to a sorting container, the sorting container will wait for the other part of the goods to arrive for a long time, and thus the utilization rate of the sorting container is not high. For this kind of goods to be sorted, the goods can be first diverged to a return device or a buffer container, when another part of the goods in the order also arrives at the position where the sorting device is located, the goods to be sorted can be then transferred back to the transfer device docked with the sorting device through the return device, or the goods to be sorted are transported to the transfer device docked with the sorting device by the staff or transport robot, so as to transfer the goods to be sorted via the transfer device to the sorting device for sorting operations.

In some embodiments, if it is found that there are not enough idle sorting containers that can accommodate all the goods in the target order to which the goods to be sorted belong, the goods to be sorted can be diverged out, the sorting operation will not be performed for the goods to be sorted temporarily, and when there are enough idle sorting containers, the sorting operation will be performed on the goods to be sorted. In this way, it can avoid occupying the position of the material bin on the sorting device for a long time because the goods to be sorted cannot be delivered, instead, the material bin is used to place the goods to be sorted corresponding to other orders that have completed the sorting of partial goods, thereby improving the overall sorting efficiency.

In some embodiments, due to the existence of the moving speed of the material bin on the sorting device being greater than the moving speed of the device of the sorting container moving device, if the goods to be sorted are delivered goods, and the goods to be sorted on the two adjacent material bins (that is, the goods to be sorted and the last goods to be sorted) need to be delivered to different sorting containers on the same sorting container moving device, then after one sorting container on the sorting container moving device receives the last goods to be sorted, another sorting container on the sorting container moving device cannot move to the goods receiving position when the goods to be sorted reach the corresponding delivery port in the current period, and therefore, the goods to be sorted can be subjected to diversion processing, such that after any goods in the order corresponding to the goods to be sorted arrives, the goods to be sorted and any goods can be delivered to adjacent material bins, or based on the moving speed of the material bins and the moving speed of the device, the target material bins corresponding to the goods to be sorted are determined, etc., so as to deliver the goods on the material bins to the sorting containers as soon as possible, and release the material bins on the sorting device.

In the embodiments of the disclosure, the goods need to be picked from the shelves of the warehouse, currently, the goods can be picked from the shelves by manual and/or automatic modes (such as smart picking machines, etc.), such that the picked goods are transported to the system for processing goods described in FIG. 1 for sorting operations. In a scenario, the warehouse can be partitioned to obtain multiple partitions, which can be used to pick the goods synchronously, and if multiple goods in the same order are located in different partitions, it is possible that in part of the partitions, part of the goods in the same order have been picked and delivered to the system for processing goods, and in another part of the partitions, another part of the goods in the same order have not been picked, in this way, if the part of the goods that have been picked are delivered to the sorting container, it may take a long time to wait for the delivery of another part of the goods in the same order, resulting in the same order occupying the sorting container for a long time; in another scenario, the warehouse is not partitioned, and the goods can be picked by pickers, that is, when walking in the warehouse, the pickers can pick out the goods that need to be picked in the path traversed, and transport the picked goods to the system for processing goods, but there may be a problem of missing part of the goods in a certain order in the path traversed, and if the picked goods in the certain order are delivered to the sorting container, it will take a long time to wait for the delivery of the part of the goods in the certain order. Based on the problems in the first scenario and the second scenario, the respective order can be sorted, in the present disclosure, through the system for processing goods to obtain the sorting sequence numbers of the respective orders, such that it can be determined whether to deliver the goods included in the order based on the sorting sequence numbers, thereby the above-mentioned problem of occupying the sorting container for a long time is avoided.

Herein, the sorting sequence numbers can be determined in the following manners: first, the arrival times of a plurality of picking containers are obtained; the plurality of picking containers accommodate multiple goods; the plurality of picking containers are then sequenced based on the arrival times; subsequently, based on the sequencing result, the orders in the plurality of picking containers are sequenced in turn; a sorting sequence number of the first designated order is less than a sorting sequence number of the second designated order; the arrival time of the last one of the picking containers corresponding to the goods included in the first designated order is earlier than the arrival time of the last one of the picking containers corresponding to the goods included in the second designated order; and the first designated order and the second designated order are both the orders in the picking containers.

In a possible implementation, the sorting sequence numbers of the first part of the orders in the first picking container can be obtained; the goods included in the first part of the orders are all in the first picking container; when the first part of the orders does not meet the predetermined termination conditions, the sorting sequence numbers of the second part of the orders are obtained based on the first picking container and the second picking container; all the goods included in the second part of the orders are in the first picking container and the second picking container; and the predetermined termination condition is that the total amount of orders of the first part of the orders is greater than the number of sorting containers of the idle sorting containers on all of the sorting container moving devices.

Specifically, the goods that have been picked are usually transported to the system for processing goods through a picking container (such as a picking trolley or a picking box, etc.), in this way, the system for processing goods can sequence the picking containers based on the arrival times of the picking containers to obtain the picking container queue, and then set the sorting sequence number for the goods in the first picking container included in the picking container queue. Specifically, the first order to which the first goods in the first picking container belongs can be obtained, and it can be determined whether all the goods included in the first order are in the first picking container, and if all the goods included in the first order are all in the first picking container, the sorting sequence number of the first order to which the first goods belongs can be set to 1; it is continued to obtain the second goods in the first picking container, when the first goods and the second goods do not belong to the same order, it is determined whether all the goods included in the second order to which the second goods belongs are in the first picking container, and if all the goods included in the second order are in the first picking container, the sorting sequence number of the second order to which the second goods belongs is set to 2; it is continued to obtain the third goods in the first picking container, and when the third goods and any one of the previous two goods (that is, the first and second goods) do not belong to the same order, it is determined whether all the goods included in the third order to which the third goods belongs are in the first picking container, if all the goods included in the third order are in the first picking container, the sorting sequence number of the third order to which the third goods belongs is set to 3, etc., such that the sorting sequence number of the first part of the orders that all the goods are in the first picking container can be obtained, and the goods can be delivered based on the sorting sequence numbers. In addition, when the control device detects that a certain order in the first part of the orders is in the order completed state, it is needed to update the sorting sequence number, for example, when the t-th order is in the order completed state, the orders with sorting sequence numbers greater than t need to be updated for the sorting sequence numbers, and the orders with sorting sequence numbers less than t are not updated for the sorting sequence numbers.

If the order quantity of the first part of the orders is less than or equal to the number of sorting containers of the idle sorting containers on all the sorting container moving devices, it is continued to determine the sorting sequence numbers based on the first and second picking containers, the specific process is as follows:

For the remaining part of orders that all the goods are not all in the first picking container, the sequence can be made in the following manner, since there are remaining goods in the first picking container, it can be determined whether all the goods included in the first remaining orders to which the first remaining goods belong are in the first picking container and the second picking container, and if all the goods included in the first remaining orders to which the first remaining goods belong are in the first picking container and the second picking container, when the maximum sorting sequence number in the above first part of the orders is b−1, the sorting sequence number of the first remaining orders to which the first remaining goods belong is set to b; it is then continued to determine whether all the goods included in the second remaining orders to which the second remaining goods belong are in the first picking container and the second picking container, if all the goods included in the second remaining orders to which the second remaining goods belong are in the first picking container and the second picking container, the sorting sequence number of the second remaining orders to which the second remaining goods belong is set to b+1; it is continued to determine whether all the goods included in the third remaining orders to which the third remaining goods belong are in the first picking container and the second picking container, if all the goods included in the third remaining orders to which the third remaining goods belong are in the first picking container and the second picking container, the sorting sequence number of the third remaining orders to which the third remaining goods belong is set to b+2, and so on, after sequencing the orders corresponding to the remaining goods in the first picking container, it is continued to sequence the orders corresponding to the remaining goods in the second picking container, in this way, it is possible to obtain the sorting sequence numbers of the second part of the orders where all the goods are in the first picking container and the second picking container, and to deliver the goods based on the sorting sequence numbers. In addition, if the total order quantity of the first part of the orders and the second parts of the orders is less than or equal to the number of sorting containers of the idle sorting containers on all the sorting container moving devices, it can be continued to determine the sorting sequence numbers based on the first picking container and the second picking container as well as the third picking container, until there is no idle sorting containers. Certainly, the sorting sequence number can also be determined, in the present disclosure, for the orders in the entire picking containers included in the picking container queue, which is not limited in the present disclosure.

When the goods to be sorted meet the predetermined sorting conditions, step 603 to step 608 are performed;

When the goods to be sorted do not meet the predetermined sorting conditions, step 611 and step 612 are performed.

In step 603, a target sorting container is determined from a plurality of candidate sorting containers based on the goods information, the target sorting container is located on a sorting container moving device, on which a plurality of sorting containers are placed.

The specific process can refer to step 502, which will not be repeated.

In some embodiments, when the moving speed of the material bin on the sorting device is greater than the moving speed of the sorting container moving device, if the goods to be sorted are the first delivered sorted goods, the target sorting container corresponding to the goods to be sorted can be determined by this step, at this time, considering that the sorting containers corresponding to the two adjacent goods to be sorted (that is, the previous goods to be sorted and the goods to be sorted) are different sorting containers on the same sorting container moving device, after the previous goods to be sorted are delivered to the corresponding sorting container, the sorting container moving device cannot move the sorting container corresponding to the goods to be sorted to the goods receiving position when the goods to be sorted reaches the target delivery port, therefore, in order to avoid the problem that the goods to be sorted occupy the material bin because the goods to be sorted cannot be delivered at the same time as the previous goods to be sorted in the same delivery period, it can be realized in the present disclosure that the sorting operation is temporarily not performed for the goods to be sorted. Specifically, it is judged whether the target sorting container corresponding to the goods to be sorted and the sorting container corresponding to the previous goods to be sorted are different sorting containers on the same sorting container moving device; and when the target sorting container corresponding to the goods to be sorted and the sorting container corresponding to the previous goods to be sorted are different sorting containers on the same sorting container moving device, the target material bin corresponding to the goods to be sorted is determined based on the moving speed of the material bin and the moving speed of the device, or a diversion processing of the goods to be sorted is performed, such that after any goods in the order corresponding to the goods to be sorted arrives, the goods to be sorted and any goods can be delivered to adjacent material bins.

Since the sorting device includes multiple material bins, the sorting device can control the rotation of multiple material bins, and the goods to be sorted are located on the target material bin of the sorting device; therefore, the transfer device is needed to be controlled in the present disclosure to transfer goods to be sorted to the target material bin of the sorting device, such that the goods to be sorted on the target material bin can be delivered to the target sorting container in the subsequent steps.

In step 604, the moving device position of the sorting container moving device where the target sorting container is located is acquired.

In this step, the moving device position corresponding to each sorting container moving device can be acquired through the control device in the first embodiment, such that the control device can monitor each sorting container moving device in real time, and perform the subsequent control to the sorting container moving devices.

In step 605, based on the moving device position, a converging position at which the goods to be sorted and the sorting container moving device where the target sorting container is located are converged are determined.

In some embodiments, it can be determined that the moving device position where the sorting container moving device is located is the converging position where the goods to be sorted and the sorting container moving device where the target sorting container is located are converged; in order to shorten the delivery time, in a possible implementation, the sorting container moving device is controlled to move such that the sorting container reaches the goods receiving position, at this time, the sorting container moving device can be controlled to move back and forth while also moving left and right, in this way, the sorting device and the sorting container moving device can move toward each other, such that the goods to be delivered and the sorting container moving device are converged quickly. Specifically, the moving speed of the material bin on the sorting device, the device moving speed of the sorting container moving device, and the initial transport position of the goods to be sorted are acquired, so as to determine, based on the moving speed of the material bin, the device moving speed, the initial transport position, and the device moving position, the converging position where the goods to be sorted and the sorting container moving device where the target sorting container is located are converged; in another possible implementation, a transfer apparatus, by which the sorting container is controlled to move, is disposed on the sorting container moving device, in this way, the sorting device and the sorting container can move toward each other, such that the goods to be delivered and the sorting container are converged quickly, wherein the converging position needs to be determined based on the transfer speed of the transfer device, the moving speed of the material bin on the sorting device, the initial transport position, and the initial position of the target sorting container, and the initial position being the position of the sorting container when it has not moved, and at this time, the converging position is the subsequent goods receiving position.

In step 606: the goods receiving position corresponding to the goods to be sorted is determined based on the converging position.

In the embodiments of the present disclosure, the goods receiving position is a position where the target sorting container can just receive the goods to be sorted. Herein, if the moving device position is the converging position, the goods receiving position can be the position exactly facing the delivery port at the converging position, or if the delivery port is provided with a guiding mechanism, the goods receiving position is just the position where the goods to be sorted, delivered at the output end of the guide mechanism, can be received, the guiding mechanism can be a slide rail or a conveyor belt, etc. and the above example is just illustrative, which is not limited in the present disclosure.

In step 607, the sorting device is controlled to move the goods to be sorted to a delivery port corresponding to the goods receiving position.

Since the sorting device is used to drive a plurality of material bins to rotate periodically, in this step, the goods to be sorted on the material bins can be moved to the delivery port corresponding to the goods receiving position.

In step 608: it is determine whether the target sorting container is located at the goods receiving position corresponding to the goods to be sorted.

In this step, it can be determined by a detection apparatus of the sorting device whether the target sorting container is located at the goods receiving position corresponding to the goods to be sorted, or the moving device position of the sorting container moving device can be acquired through the control device, to determine whether the target sorting container on the sorting container moving device is located in the goods receiving position corresponding to the goods to be sorted, or the position where the target sorting container is located can be acquired through the control device, so as to determine based on the position where the target sorting container is located, whether the target sorting container is located at the goods receiving position corresponding to the goods to be sorted.

When the target sorting container is located at the goods receiving position corresponding to the goods to be sorted, step 609 is performed;

when the target sorting container is not located at the goods receiving position corresponding to the goods to be sorted, step 610 is performed.

In step 609, the sorting device is controlled to deliver the goods to be sorted to the target sorting container.

The delivery process can refer to the delivery process in the first embodiment, and will not be repeated.

In step 610, the sorting container moving device is controlled to move the target sorting container to the goods receiving position, and deliver the goods to be sorted to the target sorting container via the delivery port.

In the embodiments of the present disclosure, in a possible implementation, when the sorting container moving device includes a mobile trolley, the mobile trolley can be used to move back and forth, and/or move left and right, to enable the sorting container on the mobile trolley to be moved to the goods receiving position; in another possible implementation, the sorting container moving device does not move, and a transfer apparatus can be provided on the sorting container moving device, so as to control by the transfer apparatus the sorting container on the sorting container moving device to move; in yet another possible implementation, the sorting container moving device may be a mobile trolley, and a transfer apparatus is provided on the mobile trolley, such that while the mobile trolley moves back and forth, and/or moves left and right, the sorting container on the mobile trolley can also be moved by the transfer apparatus, thereby shortening the time for the sorting container to reach the goods receiving position.

Considering that the target sorting container is not located at the goods receiving position after the sorting device arrives at the converging position in the current transport period, if the sorting device delivers the goods to be sorted in the current operation period, there is a problem of delivery errors.

Therefore, in some embodiments of the present disclosure, before delivering the goods to be sorted to the target sorting container, the following methods can be performed:

acquiring the transport duration in which the goods to be sorted are transported to the converging position in the current delivery period;

acquiring the moving duration in which the target sorting container moves to the goods receiving position; and

determining whether the target sorting container moves to the goods receiving position when the goods to be sorted move to the converging position in the current transport period, based on the transport duration and the moving duration.

Herein, when the transport duration is greater than or equal to the moving duration, it can be determined that when the goods to be sorted moves to the converging position in the current transport period, the target sorting container moves to the goods receiving position; when the transport duration is less than the moving duration, it can be determined that when the goods to be sorted moves to the converging position in the current transport cycle, the target sorting container has not moved to the goods receiving position.

That is to say, when the target sorting container can move to the goods receiving position when the goods to be sorted moves to the converging position in the current transport period, the goods to be sorted are delivered to the target sorting container; when the target sorting container does not move to the goods receiving position when the goods to be sorted moves to the converging position in the current transport period, the delivery operation is not performed in the current transport period, such that the goods to be sorted continues to move at least one more circle with the sorting device until the goods to be sorted are delivered to the target sorting container.

In an optional embodiment of the present disclosure, if the goods delivery operation is not performed in the current transport period, after the goods to be sorted continues to move with the sorting device for at least one circle, when the goods to be sorted moves to the converging position, the sorting device determines whether the target sorting container is located at the goods receiving position, such that the delivery operation is performed when it is confirmed that the target sorting container is located at the goods receiving position. For example, a detection apparatus can be installed on the sorting device, and the detection device can detect the position of the sorting container; or, the sorting container moving device can report the position of the sorting container placed thereon in real time.

In another optional embodiment of the present disclosure, the target transport period during which the sorting device needs to deliver the goods to be sorted can be determined through the control device. Herein, the unit transport duration of the sorting device can be acquired, and the unit transport duration can be the average running duration for the sorting device to run a single cycle. In this way, the approximate value of the target transport period can be calculated by the following formula: (s−1)*z+p−q>0, where s is the approximate value of the target transport period, z is the unit transport duration, p is the transport duration, and q is the moving duration, the minimum s value is calculated by the above formula, when the minimum s value is an integer, the minimum s value is the target transport period, and if the s is 3, the third transport period can be determined to be the target transport period, wherein, the current transport period can be regarded as the first transport period, when the minimum s value is a decimal number, the integer acquired after the minimum s value is carried is the target transport period, if the s is 4.3, the fifth transport period can be determined as the target transport period, and the above example is just illustrative, which is not limited in the present disclosure.

In step 611, the goods to be sorted are diverged.

In this step, the goods to be sorted can be diverged based on the diverging device in the system for processing goods.

In addition, it is considered in the present disclosure that if the goods to be sorted belong to a designated goods type, it may cause damage to the goods, or the target order to which the goods to be sorted belong includes a single goods, there is no need to perform the sorting process. Therefore, if the goods to be sorted belong to a designated goods type, and/or the target order to which the goods to be sorted belong includes a single goods, the goods to be sorted are directly transported to the next processing station.

However, if the designated goods in the target order to which the goods to be sorted belong have not all been picked; or if the designated goods in the target order to which the goods to be sorted belong cannot reach the sorting device within the predetermined time period; or if the number of idle sorting containers on all the sorting container moving devices is less than the number of containers occupied by all the goods in the target order to which the goods to be sorted belong; and, if the current sorting sequence number corresponding to the target order to which the goods to be sorted belong is greater than the sorting container number of the idle sorting containers on all the sorting container moving devices, as the order corresponding to the sorting container is sorted, the current sorting sequence number of the goods to be sorted may change, and the number of sorting containers of idle sorting containers may also change, or as the goods are continued to be picked, all the goods in the target order are completely picked or all the goods in the target order, within a predetermined time period, can arrive at the sorting device, in view of these situations, it is necessary to re-determine whether to sort the order to which the goods to be sorted belong.

In step 612, it is determined whether the goods to be sorted are goods suspended for sorting.

Herein, the goods suspended for sorting do not belong to the designated types of goods, and the target order to which the goods suspended for sorting belongs includes multiple goods.

When the goods to be sorted are goods suspended for sorting, step 613 is executed;

In a case that the goods to be sorted are not the goods suspended for sorting, step 614 is executed.

In step 613, the sorting processing on the goods suspended for sorting is performed, based on the current sorting sequence number corresponding to the order to which the goods to be sorted belong.

In this step, when the current sorting sequence number corresponding to the order to which the goods to be sorted belong is less than or equal to the sorting container number of the idle sorting containers on all the sorting container moving devices, the sorting processing on the goods suspended for sorting is performed.

Optionally, by monitoring whether the designated goods in the target order are picked, and when the designated goods in the target order to which the goods to be sorted belong to are all sorted, the sorting processing on the goods suspended for sorting is performed.

Optionally, by monitoring whether the designated goods in the target order arrive at the sorting device within a predetermined time period, and when the designated goods in the target order to which the goods to be sorted belong can arrive at the sorting device within the predetermined time period, the sorting processing on the goods suspended for sorting is performed.

Optionally, when the target sorting container corresponding to the goods to be sorted and the sorting container corresponding to the previous goods to be sorted are different sorting containers on the same sorting container moving device, the target material bin corresponding to the goods to be sorted is determined, based on the material bin moving speed and the device moving speed, and the goods to be sorted are transferred to the target material bin, or diversion processing of the goods to be sorted is performed, such that after any goods in the order corresponding to the goods to be sorted arrives, the goods to be sorted and any goods are delivered to the adjacent material bins.

In step 614, the goods to be sorted are transported to the next processing station.

In this way, processing operations such as order review, packing of goods, etc. can be performed at the next processing station (such as a packaging station).

By adopting the above method, the goods information of the goods to be sorted is acquired first; subsequently, the target sorting container is determined from a plurality of candidate sorting containers based on the goods information, and the target sorting container is located on the sorting container moving device, on which a plurality of sorting containers are placed; then, when the target sorting container is not located in the goods receiving position corresponding to the goods to be sorted, the sorting container moving device is controlled to move the target sorting container to the goods receiving position, and the sorting device is controlled to deliver the goods to be sorted to the target sorting container; or, when the target sorting container is located at the receiving position corresponding to the goods to be sorted, the sorting device is controlled to deliver the goods to be sorted to the target sorting container. In this way, because the plurality of sorting containers are disposed on the sorting container moving device in the present disclosure, the number of sorting containers is larger, and each sorting container can perform the order merging for a single order, and therefore a large number of orders can be merged at the same time, thereby the order merging efficiency is improved.

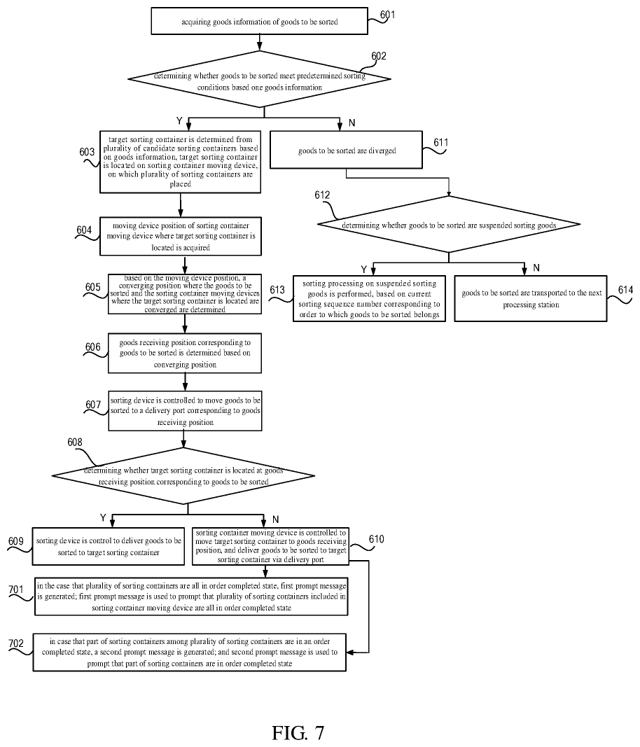

Referring to FIG. 7, there is shown a flowchart of a method for handling goods of the present disclosure, after the goods to be sorted are delivered to the target sorting container described in step 610 or step 609 (shown in FIG. 7), if the sorting container is in the order completed state, the bin of the sorting container can be changed. Herein, considering that the sorting container moving device where the target sorting container is located can include a plurality of sorting containers, therefore, for the situation that the plurality of sorting containers are all in an order completed state, it can be instructed to replace the containers in an entire row for the sorting container moving device, the specific process can refer to step 701; for part of sorting containers among the plurality of sorting containers being in the order completed state, it can be instructed to change the bin for the part of sorting containers, and the specific process can refer to step 702:

In step 701, when the plurality of sorting containers are all in the order completed state, a first prompt message is generated; and the first prompt message is used to prompt that the plurality of sorting containers included in the sorting container moving device are all in the order completed state.

In the present disclosure, because the sorting container moving device of the system for processing goods is provided with a prompting apparatus, in this way, it can be prompted by the prompting apparatus that the plurality of sorting containers included in the sorting container moving device are all in the order completed state. The specific prompt mode can refer to the prompt mode in the first embodiment.

When it is determined that the sorting container moving device where the target sorting container is located includes the plurality of sorting containers, if the plurality of sorting containers are in the order completed state, the sorting container moving device can be controlled to move from the current position to the target position which can be the position corresponding to the next processing station, and in order not to affect the sorting of goods, when the sorting container moving device moves from the current position to the target position, a new sorting container moving device can also be controlled, in the present disclosure, to move to the current position; multiple idle sorting containers are placed on the new sorting container moving device to improve the processing efficiency of the goods. Certainly, in the present disclosure, the plurality of sorting containers can also be unloaded, such as by manual unloading and/or automatic unloading, and transport the unloaded plurality of sorting containers to the next processing station through the transportation equipment, such as the transportation equipment can be Forklifts, AGVs (Automated Guided Vehicles), etc., and then multiple idle sorting containers can be placed on the sorting container moving device, such that the sorting container moving device can continue to carry out the goods processing process in the present disclosure.

In step 702, when part of sorting containers among the plurality of sorting containers are in an order completed state, a second prompt message is generated; and the second prompt message is used to prompt that the part of sorting containers are in the order completed state.

Since the sorting container moving device of the system for processing goods is provided with a prompting apparatus, in this way, it can be prompted by the prompting apparatus that the part of sorting containers included in the sorting container moving device are in the order completed state. The specific prompt mode can refer to the prompt mode in the first embodiment.

The part of the sorting containers can be unloaded based on the second prompt message in the present disclosure, such as by manual unloading and/or automatic unloading, and the unloaded part of sorting containers can be transported to the next processing station through the transportation equipment, such as the transportation equipment can be Forklifts, AGVs, and then idle sorting containers can be placed on the sorting container moving device, such that the sorting container moving device can continue to carry out the goods processing process in the present disclosure; or the sorting container moving device where the plurality of the sorting containers are located can moved to the next processing station in the present disclosure, and in order not to affect the sorting of goods, a new sorting container moving device can also be relocated in the sorting processing system, in the present disclosure, to improve the processing efficiency of the goods.

Considering that the user is prompted to replace the part of the sorting containers through the second prompt message in the present disclosure. However, replacing the part of the sorting containers on the sorting container moving device has the problem of cumbersome replacement operations, therefore, it can also be determined in the present disclosure whether to replace the part of the sorting containers in the following two modes, and when determining to replace the part of the sorting containers, a second prompt message is generated.

Mode one, first, the number of boxes of idle sorting containers on all the sorting container mobile devices, the number of containers released in a specified time period, and the number of containers newly occupied in a specified time period are acquired; the specified time period is the time period between the first time and the second time; the first time is the time when the part of sorting containers are in the order completed state, and the second time is the time when the plurality of sorting containers on the sorting container moving device where the part of sorting containers are located are all in the order completed state. Herein, the number of containers released refers to the number of sorting containers released in accordance with the mode of replacing the sorting containers in the entire row (that is, the mode of replacing all the sorting containers on the sorting container moving device). In addition, the number of newly occupied containers in the present disclosure can be the following: one is to occupy a single sorting container for each order, therefore, the number of newly occupied containers is the number of orders allocated for sorting within a specified time period; the other is that a single order may need to occupy a plurality of sorting containers, and therefore, the number of newly occupied containers is required to be determined in accordance with the number of sorting containers occupied by each of the orders which are allocated for sorting within a specified time period.

Next, based on the number of boxes, the number of released containers, and the number of newly occupied containers, it is determined whether to replace part of sorting containers.

In this step, the quantity of free boxes can be acquired by the number of boxes, the number of released containers, and the number of newly occupied containers, that is, a sum of the number of boxes and the number of released containers is calculated first, and then a difference between the sum and the number of the new occupied containers is calculated. In this way, when the difference is less than or equal to the predetermined difference threshold (such as 0), the part of sorting containers are determined to be replaced; when the difference is greater than the predetermined difference threshold, the replacement of the part of sorting containers is not performed at this time, and when it is detected at the second moment that all the sorting containers on the sorting container moving device are in the order completed state, all of the sorting containers on the sorting container moving devices where the part of sorting containers are located are replaced.

Then, when it is determined to replace the part of sorting containers, the second prompt message is generated.

In the cased that it is determined not to replace part of the sorting containers based on the number of boxes, the number of released containers, and the number of newly occupied containers, the second prompt message is not generated.

Mode two, first, an order warehouse-out time of a sorting container to be out of the warehouse is acquired; and the sorting container to be out of the warehouse is any sorting container among the part of sorting containers.

Considering that the order corresponding to the sorting container requires a relatively urgent warehouse-out time, the sorting container corresponding to the order with an urgent warehouse-out time in the present disclosure needs to replace the bin in time, and therefore, it is necessary to acquire the order warehouse-out time.

Next, based on the predetermined processing duration and the order warehouse-out time, the replacing time period of the sorting container to be out of the warehouse is acquired.

In this step, the predetermined processing duration is the duration required for processing by the subsequent processing station, which can be given based on empirical values. The end time of the replacing time period is a time acquired by subscribing the predetermined processing duration from the order warehouse-out time, and the start time of the replacing time period is a time acquired by subscribing the specified duration from the end time. For example, if the order warehouse-out time is 12:00 noon on Apr. 9, 2019, the order processing duration is 20 minutes, and the specified duration is 10 minutes, the replacing time period is the time period between 11:30 noon on Apr. 9, 2019 and 11:40 noon on Apr. 9, 2019.

Finally, within the replacing time period, the second prompt message is generated.

In the present disclosure, in order to avoid the lag of warehouse-out in the emergency warehouse-out order, a prompt to replace the bin can be provided by determining the replacing time period, so as to perform the subsequent warehouse-out processing.

By adopting the above method, there exist in the present disclosure that all the sorting containers on the sorting container moving device are in an order uncompleted state, and that part of sorting containers on the sorting container moving device are in an order uncompleted state, for all the sorting containers on the sorting container moving device being in an order uncompleted state, it is necessary to replace the whole row of the sorting containers for the sorting container moving device in time, whereas for the part of sorting containers on the sorting container moving device being in the order uncompleted state, it can be decided whether to replace the bin for the part of the sorting containers, such that in the present disclosure different prompts can be given to the above two situations.

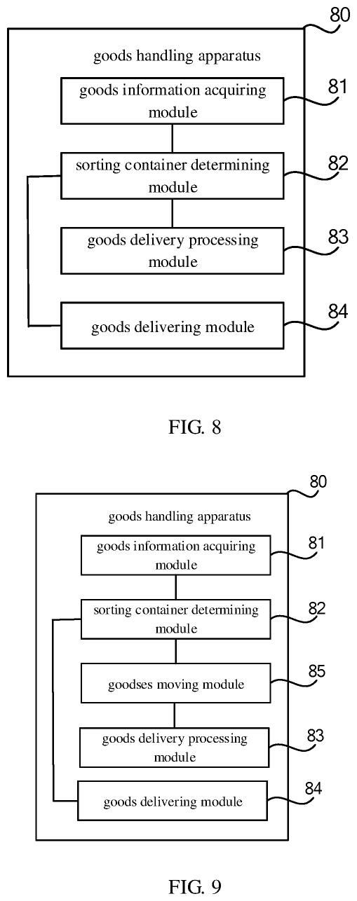

Referring to FIG. 8, a structural block diagram of an embodiment of an apparatus for handling goods 80 is shown, which can specifically include the following modules:

a goods information acquiring module 81 configured to acquire the goods information of the goods to be sorted;

a sorting container determining module 82 configured to determine a target sorting container from a plurality of candidate sorting containers based on the goods information; and

a goods delivery processing module 83 configured to, when the target sorting container is not located at the goods receiving position corresponding to the goods to be sorted, control the sorting device to move the target sorting container to the goods receiving position, and deliver the goods to be sorted to the target sorting container; or,

a goods delivering module 84 configured to, when the target sorting container is located at the goods receiving position corresponding to the goods to be sorted, control the sorting device to deliver the goods to be sorted to the target sorting device.

Referring to FIG. 9, in an optional embodiment of the present disclosure, the apparatus further includes:

a goods moving module 85 configured to control the sorting device to move the goods to be sorted to the delivery port corresponding to the goods receiving position; and

the goods delivery processing module 83 being configured to deliver the goods to be sorted to the target sorting container via the delivery port.

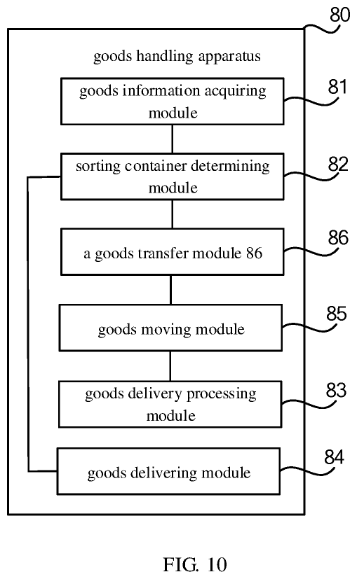

Referring to FIG. 10, in an optional embodiment of the present disclosure, the sorting device includes a plurality of material bins, and the sorting device controls the rotation of the plurality of material bins, and the goods to be sorted are located on the target material bin of the sorting device; and

the apparatus further includes:

a goods transfer module 86 configured to control the transfer device to transfer the goods to be sorted to the target material bin of the sorting device.

In an optional embodiment of the present disclosure, the sorting container determining module 82 is configured to determine the target order to which the goods to be sorted belong based on the goods information;

determine whether the goods to be sorted belong to the first delivery sorted goods in the target order;

when the goods to be sorted belongs to the first delivery sorted goods in the target order, determine the target sorting container corresponds to the target order from the plurality of candidate sorting containers, based on predetermined screening conditions;

when the goods to be sorted do not belong to the first delivered sorted goods in the target order, acquire the target sorting container corresponding to the target order; and

the predetermined screening conditions include: the target sorting container is in an unoccupied state.

In an optional embodiment of the present disclosure, the sorting container determining module 82 is further configured to determine the target order to which the goods to be sorted belong based on the goods information;

determine whether the target sorting container corresponding to the target order is full;

when the target sorting container is full, determine another target sorting container corresponding to the target order from the multiple candidate sorting containers based on predetermined screening conditions; and

the predetermined screening conditions include: the target sorting container is in an unoccupied state.

In an optional embodiment of the present disclosure, the predetermined screening conditions further include:

the time difference between the sorting completion times corresponding to any two sorting containers located on the same sorting container moving device is less than or equal to a predetermined time threshold; and/or,

the box model of the sorting container and the total volume of all the goods included in the corresponding order conform to a predetermined correspondence relationship; and the predetermined correspondence relationship includes the correspondence relationship between different box models and a scope of the total volume of the goods.

Referring to FIG. 11, in an optional embodiment of the present disclosure, the apparatus further includes:

a device position acquiring module 87 configured to acquire the moving device position of the sorting container moving device where the target sorting container is located;

a converging position acquiring module 88 configured to determine the converging position at which the goods to be sorted and the sorting container moving device where the target sorting container is located are converged based on the moving device position; and

a receiving position acquiring module 89 configured to determine the goods receiving position corresponding to the goods to be sorted based on the converging position.

In an optional embodiment of the present disclosure, the converging position acquiring module 88 is configured to determine that the moving device position is a converging position at which the goods to be sorted and the sorting container moving device where the target sorting container is located are converged.

In an optional embodiment of the present disclosure, the converging position acquiring module 88 is further configured to acquire the moving speed of the material bin on the sorting device, the device moving speed of the sorting container moving device, and the initial transport position of the goods to be sorted;

determine the converging position at which the goods to be sorted and the sorting container moving device where the target sorting container is located are converged, based on the moving speed of the material bin, the device moving speed, the initial transport position and the moving device position.

In an optional embodiment of the present disclosure, the goods delivery processing module 83 is further configured to acquire the transport duration of the goods to be sorted being transported to the converging position in the current transport period;

acquire the moving duration of the target sorting container moving to the goods receiving position;

determine whether the target sorting container moves to the goods receiving position when the goods to be sorted move to the converging position within the current transport period, based on the transport duration and the moving duration;

deliver the goods to be sorted to the target sorting container, when the target sorting container moves to the goods receiving position in the current transport period; and

not perform the goods delivery operation in the current transport period, when the target sorting container has not moved to the goods receiving position in the current transport period, such that the goods to be sorted continues to move at least one more circle with sorting device until the goods to be sorted are delivered to the target sorting container.

In an optional embodiment of the present disclosure, the goods delivery processing module 83 is further configured to: when the target sorting container has not moved to the goods receiving position in the current transport period, the operation of delivering goods is not performed in the current transport period, and the target transport period is acquired, in the target transport period, the goods to be sorted are delivered to the target sorting container; the target transport period is a transport period corresponding to the target sorting container moving to the goods receiving position.

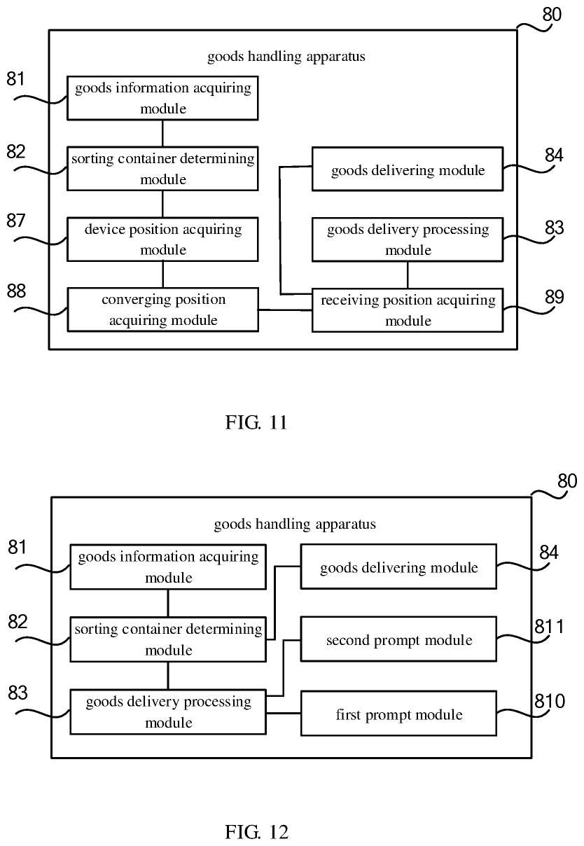

Referring to FIG. 12, in an optional embodiment of the present disclosure, the apparatus 80 further includes:

a first prompt module 810 configured to generate a first prompt message when the plurality of sorting containers are all in an order completed state; and the first prompt message being used to prompt that the plurality of sorting containers included in the sorting container moving device are all in the order completed state; and

a second prompt module 811 configured to generate a second prompt message when part of the plurality of sorting containers are in an order completed state; and the second prompt message being used to prompt that the part of the sorting containers are in the order completed state.

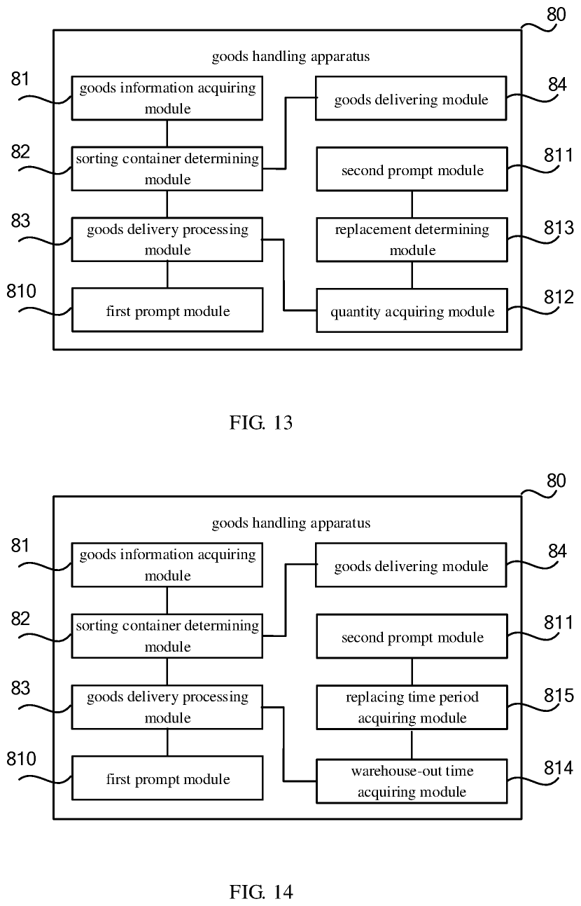

Referring to FIG. 13, in an optional embodiment of the present disclosure, the apparatus 80 further includes:

a quantity acquiring module 812 configured to acquire the number of boxes of idle sorting containers on all the sorting container moving devices, the number of containers released in a specified time period, and the number of containers newly occupied in the specified time period; the specified time period is the time period between the first time and the second time; the first time being the time when the part of sorting containers are in the order completed state, and the second time being the time when the plurality of sorting containers on the sorting container moving device where the part of sorting containers is located are all in the order completed state;

a replacement determining module 813 configured to determine whether to replace the part of sorting containers based on the number of boxes, the number of released containers, and the number of newly occupied containers; and

the second prompt module 811 being configured to generate the second prompt message when it is determined to replace the part of sorting containers.

Referring to FIG. 14, in an optional embodiment of the present disclosure, the apparatus 80 further includes:

a warehouse-out time acquiring module 814 configured to acquire the order warehouse-out time of the sorting container to be out of the warehouse; the sorting container to be out of the warehouse being any sorting container among the part of sorting containers;

a replacing time period acquiring module 815 configured to acquire the replacing time period of the sorting container to be out of the warehouse, based on the predetermined processing duration and the order warehouse-out time; and

the second prompt module 811 being configured to generate the second prompt message within the replacing time period.

In an optional embodiment of the present disclosure, the sorting container determining module 82 is further configured to determine whether the goods to be sorted meet a predetermined sorting condition based on the goods information; and

determine, in a case that the goods to be sorted meet the predetermined sorting condition, the target sorting container from the multiple candidate sorting containers based on the goods information.

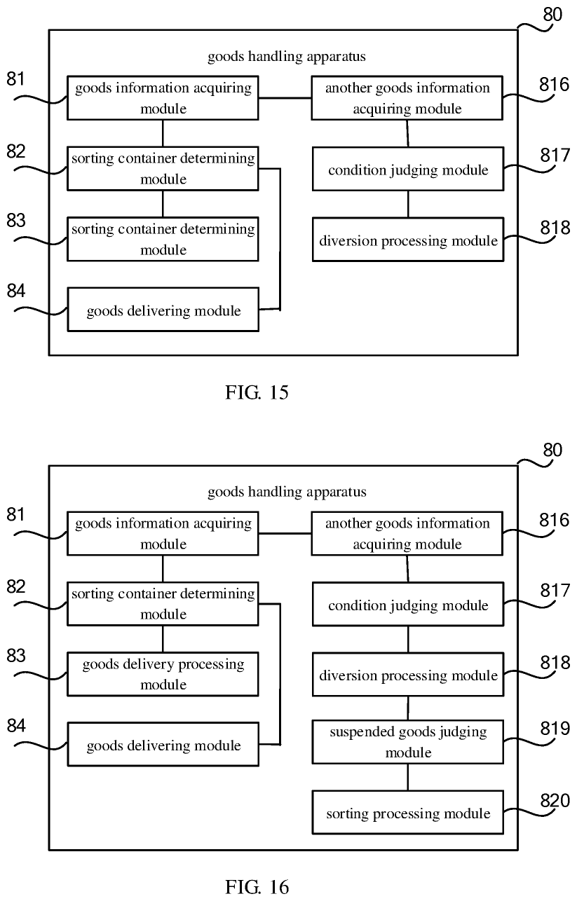

Referring to FIG. 15, in an optional embodiment of the present disclosure, the apparatus 80 further includes:

another goods information acquiring module 816, configured to acquire goods information of other goods to be sorted;

a condition judging module 817 configured to judge whether the other goods to be sorted meet a predetermined sorting condition based on the goods information of the other goods to be sorted; and

a diversion processing module 818 configured to perform diversion processing on the other goods to be sorted when the other goods to be sorted do not meet the predetermined sorting conditions.

Referring to FIG. 16, in an optional embodiment of the present disclosure, the apparatus 80 further includes:

a suspended goods judging module 819 configured to determine whether the other goods to be sorted are the goods suspended for sorting; the goods suspended for sorting do not belong to the designated types of goods, and the target order to which the goods suspended for sorting belong including multiple goods; and

a sorting processing module 820 configured to, when the other goods to be sorted are the goods suspended for sorting, perform sorting processing on the goods suspended for sorting, based on the current sorting sequence number corresponding to the order to which the other goods to be sorted belong.

In an optional embodiment of the present disclosure, the sorting processing module 820 is configured to perform the sorting processing on the goods suspended for sorting, when the current sorting sequence number corresponding to the order to which the other goods to be sorted belong is less than or equal to the sorting container number of the idle sorting containers on all the sorting container moving devices.

In an optional embodiment of the present disclosure, the predetermined sorting conditions include:

the goods to be sorted do not belong to the designated goods type;

the target order to which the goods to be sorted belong includes multiple goods;

the designated goods in the target order to which the goods to be sorted belong have all been picked; and the designated goods are goods in the target order other than the goods to be sorted;

the designated goods in the target order to which the goods to be sorted belong arrive at the sorting device within the predetermined time period;

the sorting container number of the idle sorting containers on all the sorting container moving device is greater than or equal to the number of containers occupied by all goods in the target order to which the goods to be sorted belong; and,

the current sorting sequence number corresponding to the target order to which the goods to be sorted belong is less than or equal to the sorting container number of the idle sorting containers on all the sorting container moving devices; and,

the target sorting container corresponding to the goods to be sorted and the sorting container corresponding to the previous goods to be sorted are the same sorting container, or are different sorting containers located on different sorting container moving devices.

In an optional embodiment of the present disclosure, the sorting container determining module 82 is further configured to acquire the arrival time of plurality of sorting containers; and the sorting container contains multiple goods;

the plurality of the sorting containers are sequenced based on the arrival time;

based on the sorting result, the orders in the plurality of sorting containers are sequenced in turn; the sorting sequence number of the first designated order is smaller than the sorting sequence number of the second designated order; the arrival time of the last sorting container corresponding to the goods included in the first designated order is earlier than the arrival time of the last sorting container corresponding to the goods included in the second designated order; and the first designated order and the second designated order are both orders in the sorting container.

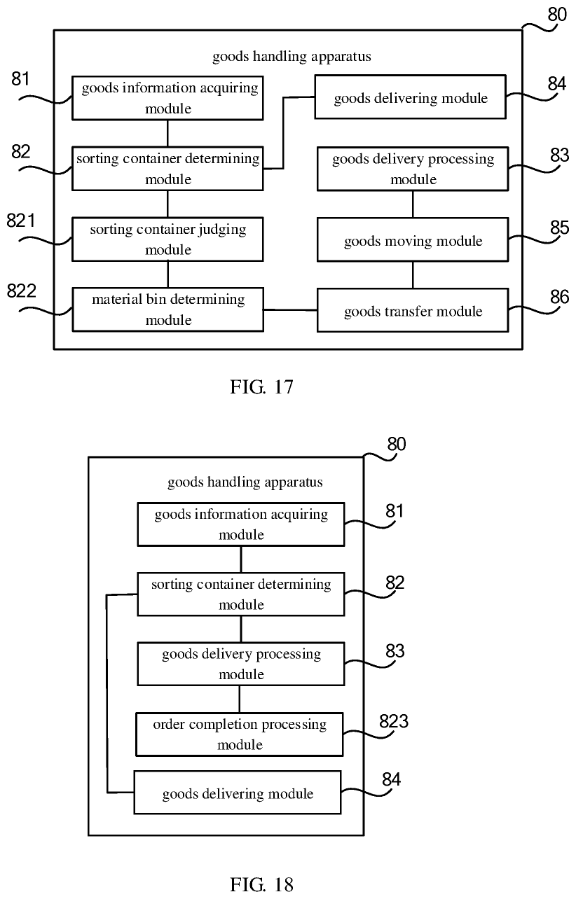

Referring to FIG. 17, in an optional embodiment of the present disclosure, the apparatus 80 further includes:

a sorting container judging module 821 configured to determine whether the target sorting container corresponding to the goods to be sorted and the sorting container corresponding to the previous goods to be sorted are different sorting containers on the same sorting container moving device; and

a material bin determining module 822 configured to determine, when the target sorting container corresponding to the goods to be sorted and the sorting container corresponding to the previous goods to be sorted are different sorting containers on the same sorting container moving device, the target material bin corresponding to the goods to be sorted, based on the moving speed of the material bin and the device moving speed.

Referring to FIG. 18, in an optional embodiment of the present disclosure, the sorting container moving device where the target sorting container is located includes a plurality of sorting containers, and the apparatus 80 further includes:

an order completion processing module 823 configured to control, when the plurality of sorting containers are all in an order completed state, the sorting container moving device to move from the current position to the target position where the next processing station is located.

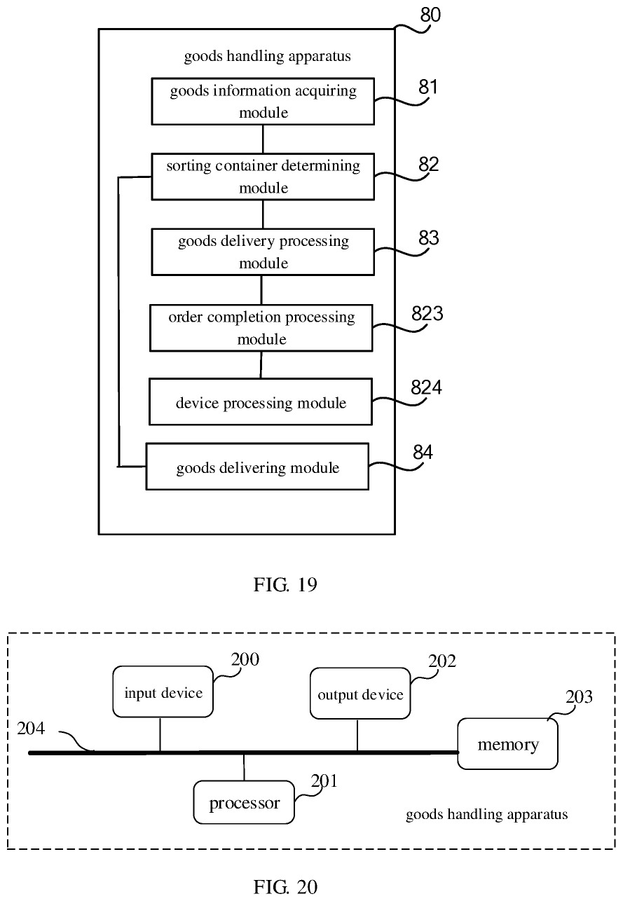

Referring to FIG. 19, in an optional embodiment of the present disclosure, the apparatus 80 further includes:

a device processing module 824 configured to control a new sorting container moving device to move to the current position; a plurality of idle sorting containers are placed on the new sorting container moving device.

By adopting the above apparatus, the goods information of the goods to be sorted is acquired first; subsequently, the target sorting container is determined from a plurality of candidate sorting containers based on the goods information, and the target sorting container is located on the sorting container moving device, on which a plurality of sorting containers are placed; then, when the target sorting container is not located in the goods receiving position corresponding to the goods to be sorted, the sorting container moving device is controlled to move the target sorting container to the goods receiving position, and the sorting device is controlled to deliver the goods to be sorted to the target sorting container; or, when the target sorting container is located at the goods receiving position corresponding to the goods to be sorted, the sorting device is controlled to deliver the goods to be sorted to the target sorting container. In this way, because the plurality of sorting containers are disposed on the sorting container moving device in the present disclosure, the number of sorting containers is larger, and each sorting container can perform the order merging for a single order, and therefore a large number of orders can be merged at the same time, thereby the order merging efficiency is improved.

The embodiments of the present disclosure also provides a non-volatile readable storage medium, having stored thereon one or more modules (programs) that, when applied to a terminal device, enable the terminal device to execute instructions of respective method steps in the embodiments of the present disclosure.

FIG. 20 is a schematic diagram of the hardware structure of an apparatus for handling goods provided by an embodiment of the disclosure. As shown in FIG. 20, the apparatus for handling goods can include an input device 200, a processor 201, an output device 202, a memory 203, and at least one communication bus 204. The communication bus 204 is configured to implement communication connections between components. The memory 203 can include a high-speed RAM memory, or can also include a non-volatile storage NVM, such as at least one disk memory, and the memory 203 can store various programs for completing various processing functions and implementing the method steps of this embodiment.

Optionally, the aforementioned processor 201 can be, for example, a Central Processing Unit (CPU for short), an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic component implementations, the processor 201 is coupled to the aforementioned input device 200 and output device 202 via a wired or wireless connection.

Optionally, the aforementioned input device 200 can include multiple input devices, for example, can include at least one of a user-oriented user interface, a device-oriented device interface, a software programmable interface, a camera, and a sensor. Optionally, the device-oriented device interface can be a wired interface for data transmission between the device and the device, or a hardware plug-in interface for data transmission between the device and the device (such as a USB interface, a serial port, etc.); optionally, the user-oriented user interface can be, for example, user-oriented control buttons, a voice input device for receiving voice input, and a touch-sensing device for receiving user touch input (such as a touch screen with touch-sensing function, touch control board, etc.); optionally, the programmable interface of the above software can be, for example, an entry for the user to edit or modify the program, such as the input pin interface or input interface of the chip, etc.; optionally, the above transceiver can be a RF transceiver chip having the communication function, baseband processing chip and transceiver antenna, etc. Audio input devices such as microphones can receive voice data. The output device 202 can include output devices such as a display, a speaker, etc.

In this embodiment, the processor of the apparatus for handling goods includes the functions of each module in the setting apparatus executing the background, specific functions and technical effects can refer to the above-mentioned embodiments, which will not be repeated here.

As for the apparatus embodiments, since it is basically similar to the method embodiments, the description is relatively simple, and related details can refer to the part of the description of the method embodiments.

The embodiments of the present disclosure includes the following advantages:

the method for handling goods in the embodiments of the application includes: acquiring goods information of a goods to be sorted; determining, according to the goods information, a target sorting container from a plurality of candidate sorting containers, wherein the target sorting container is located on a sorting container moving device, on which a plurality of sorting containers are placed; controlling the sorting container moving device to move the target sorting container to a goods receiving position, and controlling a sorting device to deliver the goods to be sorted to the target sorting container, when the target sorting container is not located at the goods receiving position corresponding to the goods to be sorted; or controlling the sorting device to deliver the goods to be sorted to the target sorting container, when the target sorting container is located at a goods receiving position corresponding to the goods to be sorted. In this way, because a plurality of sorting containers are provided on the sorting container moving device in the present disclosure, the number of the sorting containers is larger, and the target sorting container can be moved to the goods receiving position by controlling the sorting container moving device, such that each sorting container can perform order merging for a single order, and therefore, it is possible to perform the order merging for a large number of orders at the same time, which improves the efficiency of the order merging.

The various embodiments in this specification are described in a progressive manner, and each embodiment focuses on the differences from other embodiments, and the same or similar parts between the various embodiments can be referred to each other.

Those skilled in the art should understand that the embodiments of the embodiments of the present disclosure can be provided as method, apparatus, or computer program product. Therefore, the embodiments of the present disclosure can adopt the form of a complete hardware embodiment, a complete software embodiment, or an embodiment combining software and hardware. Moreover, the embodiments of the present disclosure can adopt the form of computer program products implemented on one or more computer-usable storage media (including but not limited to disk storage, CD-ROM, optical storage, etc.) containing computer-usable program codes.

The embodiments of the present disclosure are described with reference to the flowcharts and/or block diagrams of the methods, terminal devices (systems), and computer program products according to the embodiments of the present disclosure. It should be understood that each process and/or block in the flowchart and/or block diagram, and the combination of processes and/or blocks in the flowchart and/or block diagram can be realized by computer program instructions. These computer program instructions can be provided to the processors of general-purpose computers, special-purpose computers, embedded processors, or other programmable goods processing terminal equipment to generate a machine, such that the apparatus for realizing the functions specified in a flow or multiple flows in the flowchart and/or a block or multiple blocks in the block diagram is generated through the instructions executed by the processor of the computer or other programmable goods processing terminal equipment.

These computer program instructions can also be stored in a computer-readable memory that can guide a computer or other programmable goods processing terminal equipment to work in a specific manner, such that the instructions stored in the computer-readable memory generate the manufactured product including the instruction apparatus, which realizes the functions specified in one or more processes in the flowchart and/or one or more blocks in the block diagram.

These computer program instructions can also be loaded on a computer or other programmable goods processing terminal equipment, such that a series of operation steps are executed on the computer or other programmable terminal equipment to produce computer-implemented processing, thereby the instructions executed on the computer or other programmable terminal equipment provide steps for implementing the functions specified in one or more processes in the flowchart and/or one or more blocks in the block diagram.

Although the preferred embodiments of the embodiments of the present disclosure have been described, those skilled in the art can make additional changes and modifications to these embodiments once they learn the basic creative concept. Therefore, the appended claims are intended to be interpreted as including the preferred embodiments and all changes and modifications falling into the scope of the embodiments of the present disclosure.

Finally, it should be noted that in the specification, relationship terms such as first and second are only used to distinguish one entity or operation from another entity or operation, and do not necessarily require or imply that there is any such actual relationship or order between these entities or operations. Moreover, the terms “comprise”, “include” or any other variants thereof are intended to cover non-exclusive inclusion, such that a process, method, article, or terminal device that includes a series of elements includes not only these elements, but also other elements not explicitly listed, or also include elements inherent to this process, method, article, or terminal device. When there are no more restrictions, the element defined by the sentence “including a . . . ” does not exclude the existence of other identical elements in the process, method, article, or terminal device that includes the elements.

The system for processing goods and the sorting container moving apparatus provided by the present disclosure are described in detail above, specific examples are used in this specification to illustrate the principles and implementation of the present disclosure, and the description of the above embodiments is only used to help understand the methods and core ideas of the present disclosure; at the same time, for those of ordinary skill in the art, based on the ideas of the present disclosure, there will be changes in the specific implementation and scope of application, in summary, the content of the specification should not be construed as a limitation to the present disclosure.

1. A method for handling goods, wherein the method comprises:
acquiring goods information of a goods to be sorted;
determining, according to the goods information, a target sorting container from a plurality of candidate sorting containers, the target sorting container being located on a sorting container moving device, on which a plurality of sorting containers are placed;
controlling the sorting container moving device to move the target sorting container to a goods receiving position, and controlling a sorting device to deliver the goods to be sorted to the target sorting container, when the target sorting container is not located at the goods receiving position corresponding to the goods to be sorted; or
controlling the sorting device to deliver the goods to be sorted to the target sorting container, when the target sorting container is located at the goods receiving position corresponding to the goods to be sorted.

2. The method according to claim 1, wherein prior to the controlling the sorting device to deliver the goods to be sorted to the target sorting container, the method further comprises:
controlling the sorting device to move the goods to be sorted to a delivery port corresponding to the goods receiving position;
the controlling the sorting device to deliver the goods to be sorted to the target sorting container comprises:
delivering the goods to be sorted to the target sorting container via the delivery port.

3. The method according to claim 2, wherein the sorting device comprises a plurality of material bins, which are controlled to rotate by the sorting device, and the goods to be sorted are located on a target material bin of the sorting device;
the method further comprises:
controlling the transfer device to transfer the goods to be sorted to the target material bin of the sorting device.

4. The method according to claim 1, wherein the determining, according to the goods information, the target sorting container from the plurality of candidate sorting containers comprises:
determining a target order to which the goods to be sorted belongs based on the goods information;
determining whether the goods to be sorted belongs to a first delivered sorted goods in the target order;
determining the target sorting container corresponding to the target order from the plurality of candidate sorting containers, based on predetermined screening conditions, when the goods to be sorted belongs to the first delivered sorted goods in the target order; and
acquiring the target sorting container corresponding to the target order, when the goods to be sorted do not belong to the first delivered sorted goods in the target order; and
the predetermined screening conditions comprise: the target sorting container is in an unoccupied state.

5. The method according to claim 1, wherein the determining, according to the goods information, the target sorting container from the plurality of candidate sorting containers comprises:
determining a target order to which the goods to be sorted belongs based on the goods information;
determining whether the target sorting container corresponding to the target order is full; and
determining another target sorting container corresponding to the target order from the plurality of candidate sorting containers based on predetermined screening conditions, when the target sorting container is full; and
the predetermined screening conditions comprise: the target sorting container is in an unoccupied state.

6. The method according to claim 4, wherein the predetermined screening conditions further comprise:
a time difference between sorting completed times corresponding to any two sorting containers located on the same sorting container moving device is less than or equal to a predetermined time threshold; and/or,
a box model of the sorting container and a total volume of all the goods comprised in the corresponding order conform to a predetermined correspondence relationship; and the predetermined correspondence relationship comprises a correspondence relationship between different box models and a scope of the total volume of the goods.

7. The method according to claim 1, wherein prior to moving the target sorting container to the goods receiving position, the method further comprises:
acquiring a moving device position of the sorting container moving device where the target sorting container is located;
determining a converging position at which the goods to be sorted and the sorting container moving device where the target sorting container is located are converged, based on the moving device position; and
determining the goods receiving position corresponding to the goods to be sorted, based on the converging position.

8. The method according to claim 7, wherein the determining a converging position at which the goods to be sorted and the sorting container moving device where the target sorting container is located are converged, based on the moving device position comprises:
determining that the moving device position is the converging position where the goods to be sorted and the sorting container moving device where the target sorting container is located are converged.

9. The method according to claim 7, wherein the determining a converging position at which the goods to be sorted and the sorting container moving device where the target sorting container is located are converged, based on the moving device position comprises:
acquiring a moving speed of the material bin on the sorting device, a device moving speed of the sorting container moving device, and an initial transport position of the goods to be sorted; and
determining, based on the moving speed of the material bin, the device moving speed, the initial transport position, and the device moving position, the converging position where the goods to be sorted and the sorting container moving device where the target sorting container is located are converged.

10. The method according to claim 7, wherein the method further comprises:
acquiring a transport duration in which the goods to be sorted are transported to the converging position in a current delivery period;
acquiring a moving duration in which the target sorting container moves to the goods receiving position; and
determining whether the target sorting container moves to the goods receiving position when the goods to be sorted moves to the converging position in the current transport period, based on the transport duration and the moving duration;
delivering the goods to be sorted to the target sorting container comprises:
when the target sorting container moves to the goods receiving position in the current transport period, the goods to be sorted are delivered to the target sorting container; and
when the target sorting container does not move to the goods receiving position in the current transport period, a operation of delivering goods is not performed in the current transport period, such that the goods to be sorted continues to move at least one more circle with the sorting device until the goods to be sorted are delivered to the target sorting container.

11. The method according to claim 10, wherein when the target sorting container has not moved to the goods receiving position in the current transport period, the operation of delivering goods is not performed in the current transport period, and the target transport period is acquired, in the target transport period, the goods to be sorted are delivered to the target sorting container; and the target transport period is a transport period corresponding to the target sorting container moving to the goods receiving position.

12. The method according to claim 1, wherein the sorting container moving device where the target sorting container is located comprises a plurality of sorting containers, the method further comprises:
generating a first prompt message, when the plurality of sorting containers are all in the order completed state; the first prompt message being used to prompt that the plurality of sorting containers comprised in the sorting container moving device are all in the order completed state; or
generating a second prompt message, when part of sorting containers among the plurality of sorting containers are in an order completed state; the second prompt message being used to prompt that the part of sorting containers are in the order completed state.

13. The method according to claim 12, wherein prior to the generating a second prompt message, the method further comprises:
acquiring a number of boxes of idle sorting containers on all the sorting container mobile devices, a number of containers released in a specified time period, and a number of containers newly occupied in the specified time period; the specified time period being a time period between the first time and the second time; the first time being the time when the part of sorting containers are in the order completed state, and the second time being the time when the plurality of sorting containers on the sorting container moving device where the part of sorting containers are located are all in the order completed state;
determining whether to replace the part of sorting containers, based on the number of boxes, the number of released containers, and the number of newly occupied containers; and
the generating a second prompt message comprises:
generating the second prompt message when it is determined to replace the part of sorting containers.

14. The method according to claim 12, wherein prior to the generating a second prompt message, the method further comprises:
acquiring an order warehouse-out time of a sorting container to be out of the warehouse; the sorting container to be out of the warehouse being any sorting container among the part of sorting containers;
acquiring a replacing time period of the sorting container to be out of the warehouse, based on the predetermined processing duration and the order warehouse-out time; and
the generating a second prompt message comprises:
generating the second prompt message, within the replacing time period.

15. The method according to claim 1, wherein the determining, according to the goods information, a target sorting container from a plurality of candidate sorting containers comprises:
determining whether the goods to be sorted meets predetermined sorting conditions based on the goods information; and
determining, when the goods to be sorted meets the predetermined sorting condition, the target sorting container from the plurality of candidate sorting containers based on the goods information.

16. The method according to claim 1, wherein the method further comprises:
acquiring goods information of other goods to be sorted;
determining whether the other goods to be sorted meets predetermined sorting conditions based on the goods information of the other goods to be sorted; and
performing diversion processing on the other goods to be sorted when the other goods to be sorted does not meet the predetermined sorting conditions.

17. The method according to claim 16, wherein after the performing diversion processing on the other goods to be sorted, the method further comprises:
determining whether the other goods to be sorted are goods suspended for sorting; wherein the goods suspended for sorting do not belong to the designated goods types, and the target order to which the goods suspended for sorting belongs comprises multiple goods; and
performing sorting processing on the goods suspended for sorting based on a current sorting sequence number corresponding to the order to which the other goods to be sorted belongs, when the other goods to be sorted are goods suspended for sorting.

18. The method according to claim 17, wherein the performing sorting processing on the goods suspended for sorting based on a current sorting sequence number corresponding to the order to which the other goods to be sorted belongs comprises:
performing the sorting processing on the goods suspended for sorting, when the current sorting sequence number corresponding to the order to which the other goods to be sorted belongs is less than or equal to a sorting container number of the idle sorting containers on all the sorting container moving devices.

19. (canceled)

20. (canceled)

21. (canceled)

22. (canceled)

23. (canceled)

24. An apparatus for handling goods, wherein the apparatus comprises: a processor and a memory, wherein the processor is configured to:
acquire goods information of a goods to be sorted;
determine, according to the goods information, a target sorting container from a plurality of candidate sorting containers;
control the sorting device to move the target sorting container to a goods receiving position, and to deliver the goods to be sorted to the target sorting container, when the target sorting container is not located at the goods receiving position corresponding to the goods to be sorted; or
control the sorting device to deliver the goods to be sorted to the target sorting container, when the target sorting container is located at the goods receiving position corresponding to the goods to be sorted.

25. (canceled)

26. A computer readable storage medium, wherein the computer readable storage medium has stored thereon computer programs that, when executed by a processor, implement the steps of the method for handling goods according to claim 1.
